(19) United States
(12) Patent Application Publication
(10) Pub. No.: US 2022/0036175 A1
(43) Pub. Date: Feb. 3, 2022

(54) MACHINE LEARNING-BASED ISSUE CLASSIFICATION UTILIZING COMBINED REPRESENTATIONS OF SEMANTIC AND STATE TRANSITION GRAPHS

(71) Applicant: Dell Products L.P., Round Rock, TX (US)

(72) Inventors: Varadharajan Krishnamurthy, Bangalore (IN); Nikhil Pularru, Bangalore (IN); Mohammad Rafey, Bangalore (IN)

(21) Appl. No.: 16/944,414

(22) Filed: Jul. 31, 2020

(51) Int. Cl. G06N 3/08; G06N 3/04

(52) U.S. Cl. CPC G06N 3/08; G06N 3/04

(57) ABSTRACT

An apparatus comprises a processing device configured to obtain, for a given issue associated with one or more assets of an information technology infrastructure, a description of the given issue and system logs characterizing operation of the one or more assets. The processing device is also configured to generate one or more semantic graphs characterizing the description of the given issue and one or more state transition graphs characterizing a sequence of occurrence of states of the operation of the one or more assets. The processing device is further configured to provide a combined representation of the semantic and state transition graphs for the given issue to a machine learning model, to identify recommended classifications for the given issue based on an output of the machine learning model, and to initiate remedial action in the information technology infrastructure based on the recommended classifications for the given issue.

### FIELD

The field relates generally to information processing, and more particularly to techniques for issue management utilizing machine learning.

### BACKGROUND

Issue diagnosis and remediation is an important aspect of managing information technology (IT) infrastructure. IT infrastructure may include various systems and products, both hardware and software. Issue tracking and analysis systems may receive user-submitted issues relating to errors encountered during use of the various systems and products of an IT infrastructure. As the number of different systems and products in the IT infrastructure increases along with the number of users of such systems and products, it is increasingly difficult to effectively manage a corresponding increasing number of user-submitted issues.

### SUMMARY

Illustrative embodiments of the present invention provide techniques for machine learning-based issue classification utilizing combined representations of semantic and state transition graphs for issues.

In one embodiment, an apparatus comprises at least one processing device comprising a processor coupled to a memory. The at least one processing device is configured to perform the step of obtaining, for a given issue associated with one or more assets of an information technology infrastructure, a description of the given issue and one or more system logs characterizing operation of the one or more assets of the information technology infrastructure. The at least one processing device is also configured to perform the step of generating one or more semantic graphs characterizing the description of the given issue and one or more state transition graphs characterizing a sequence of occurrence of one or more states of the operation of the one or more assets of the information technology infrastructure. The at least one processing device is further configured to perform the steps of providing a combined representation of the one or more semantic graphs and the one or more state transition graphs for the given issue to a machine learning model, identifying one or more recommended classifications for the given issue based at least in part on an output of the machine learning model, and initiating one or more remedial actions in the information technology infrastructure based at least in part on the one or more recommended classifications for the given issue.

These and other illustrative embodiments include, without limitation, methods, apparatus, networks, systems and processor-readable storage media.

### BRIEF DESCRIPTION OF THE DRAWINGS

FIG. 1 is a block diagram of an information processing system for machine learning-based issue classification utilizing combined representations of semantic and state transition graphs for issues in an illustrative embodiment of the invention.

FIG. 2 is a flow diagram of an exemplary process for machine learning-based issue classification utilizing combined representations of semantic and state transition graphs for issues in an illustrative embodiment.

FIGS. 3A-3D show a system for domain-driven issue analysis in an illustrative embodiment.

FIG. 4 shows examples of domain glossary corpuses in an illustrative embodiment.

FIG. 5 shows a process flow for building semantic graphs utilizing the system of FIGS. 3A-3D in an illustrative embodiment.

FIG. 6 shows examples of reported issues in an illustrative embodiment.

FIG. 7 shows an example representation of a cleaned-up issue description in an illustrative embodiment.

FIG. 8 shows an example of a semantic graph in an illustrative embodiment. FIG. 9 shows a process flow for building state transition graphs utilizing the system of FIGS. 3A-3D in an illustrative embodiment.

FIG. 10 shows examples of application logs in an illustrative embodiment.

FIG. 11 shows an example representation of cleaned-up system logs in an illustrative embodiment.

FIG. 12 shows an example of a state transition graph in an illustrative embodiment.

FIG. 13 shows a process for building a final graph from a state transition sub graph and a semantic sub graph in an illustrative embodiment.

FIG. 14 shows a final graph represented using an adjacency matrix and a feature matrix in an illustrative embodiment.

FIG. 15 shows examples of a semantic graph, state transition graph and root cause generated for one of the reported issues of FIG. 6 in an illustrative embodiment.

FIG. 16 shows an example final graph created from the semantic graph and state transition graph of FIG. 15 in an illustrative embodiment.

FIG. 17 shows an example of corpus and graph information for a domain stored in the knowledge store of the system of FIGS. 3A-3D in an illustrative embodiment.

FIG. 18 shows a process flow for classifying an issue utilizing the system of FIGS. 3A-3D in an illustrative embodiment.

FIG. 19 shows a visualization of issue classification utilizing a graph convolutional neural network in an illustrative embodiment.

FIG. 20 shows an adjacency matrix for the final graph of FIG. 16 in an illustrative embodiment.

FIG. 21 illustrates a process flow for a domain corpus building operation mode of the system of FIGS. 3A-3D in an illustrative embodiment.

FIG. 22 illustrates a process flow for a semantic graph building operation mode of the system of FIGS. 3A-3D in an illustrative embodiment.

FIG. 23 illustrates a process flow for a log ingestion and state transition graph building operation mode of the system of FIGS. 3A-3D in an illustrative embodiment.

FIG. 24 illustrates a process flow for a deep learning training operation mode of the system of FIGS. 3A-3D in an illustrative embodiment.

FIG. 25 illustrates a process flow for a deep learning recommendation operation mode of the system of FIGS. 3A-3D in an illustrative embodiment.

FIGS. 26 and 27 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

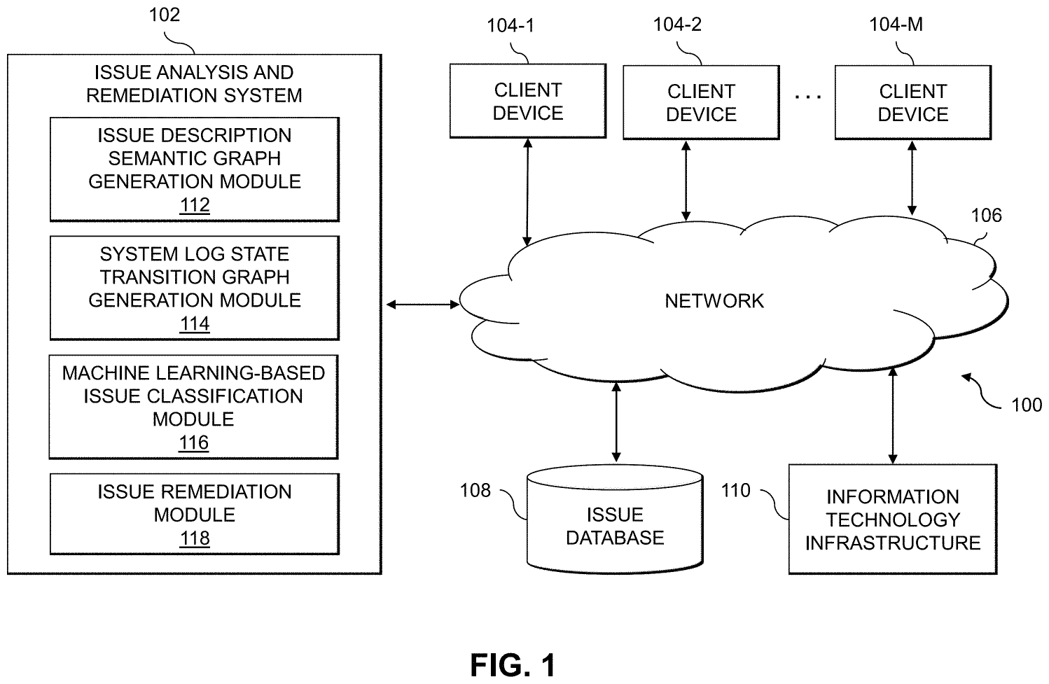

FIG. 1 shows an information processing system 100 configured in accordance with an illustrative embodiment. The information processing system 100 is assumed to be built on at least one processing platform and provides functionality for machine learning-based issue classification utilizing combined representations of semantic and state transition graphs for issues. The information processing system 100 includes an issue analysis and remediation system 102 and a plurality of client devices 104-1, 104-2, . . . 104-M (collectively client devices 104). The issue analysis and remediation system 102 and client devices 104 are coupled to a network 106. Also coupled to the network 106 is an issue database 108, which may store various information relating to issues encountered during use of a plurality of assets of information technology (IT) infrastructure 110 also coupled to the network 106. The assets may include, by way of example, physical and virtual computing resources in the IT infrastructure 110. Physical computing resources may include physical hardware such as servers, storage systems, networking equipment, Internet of Things (IoT) devices, other types of processing and computing devices, etc. Virtual computing resources may include virtual machines (VMs), software containers, etc.

The assets of the IT infrastructure 110 (e.g., physical and virtual computing resources thereof) may host applications or other software that are utilized by respective ones of the client devices 104. In some embodiments, the applications or software are designed for delivery from assets in the IT infrastructure 110 to users (e.g., of client devices 104) over the network 106. Various other examples are possible, such as where one or more applications or other software are used internal to the IT infrastructure 110 and not exposed to the client devices 104. It should be appreciated that, in some embodiments, some of the assets of the IT infrastructure 110 may themselves be viewed as applications or more generally software. For example, virtual computing resources implemented as software containers may represent software that is utilized by users of the client devices 104.

The client devices 104 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 104 may also or alternately comprise virtualized computing resources, such as VMs, software containers, etc.

The client devices 104 in some embodiments comprise respective computers associated with a particular company, organization or other enterprise. In addition, at least portions of the system 100 may also be referred to herein as collectively comprising an “enterprise.” Numerous other operating scenarios involving a wide variety of different types and arrangements of processing nodes are possible, as will be appreciated by those skilled in the art.

The network 106 is assumed to comprise a global computer network such as the Internet, although other types of networks can be part of the network 106, including a wide area network (WAN), a local area network (LAN), a satellite network, a telephone or cable network, a cellular network, a wireless network such as a WiFi or WiMAX network, or various portions or combinations of these and other types of networks.

The issue database 108, as discussed above, is configured to store and record information relating to issues encountered during use of the assets of the IT infrastructure 110. Such information may include, for example, domain glossary corpuses of keywords or other terms for different subjects of one or more product or system domains, state corpuses for the one or more product or system domains, issue descriptions, semantic graphs generated from the issue descriptions, application or system logs, state transition graphs generated from the application or system logs, final graphs generated as combinations of semantic and state transition graphs, feature, identity and label matrices for different issues, etc. Various other information may be stored in the issue database 108 in other embodiments as discussed in further detail below.

The issue database 108 in some embodiments is implemented using one or more storage systems or devices associated with the issue analysis and remediation system 102. In some embodiments, one or more of the storage systems utilized to implement the issue database 108 comprises a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the issue analysis and remediation system 102, as well as to support communication between the issue analysis and remediation system 102 and other related systems and devices not explicitly shown.

The client devices 104 are configured to access or otherwise utilize assets of the IT infrastructure 110 (e.g., hardware assets, applications or other software running on or hosted by such hardware assets, etc.). In some embodiments, the assets (e.g., physical and virtual computing resources) of the IT infrastructure 110 are operated by or otherwise associated with one or more companies, businesses, organizations, enterprises, or other entities. For example, in some embodiments the assets of the IT infrastructure 110 may be operated by a single entity, such as in the case of a private data center of a particular company. In other embodiments, the assets of the IT infrastructure 110 may be associated with multiple different entities, such as in the case where the assets of the IT infrastructure 110 provide a cloud computing platform or other data center where resources are shared amongst multiple different entities.

The term “user” herein is intended to be broadly construed so as to encompass numerous arrangements of human, hardware, software or firmware entities, as well as combinations of such entities.

In the present embodiment, alerts or notifications generated by the issue analysis and remediation system 102 are provided over network 106 to client devices 104, or to a system administrator, IT manager, or other authorized personnel via one or more host agents. Such host agents may be implemented via the client devices 104 or by other computing or processing devices associated with a system administrator, IT manager or other authorized personnel. Such devices can illustratively comprise mobile telephones, laptop computers, tablet computers, desktop computers, or other types of computers or processing devices configured for communication over network 106 with the issue analysis and remediation system 102. For example, a given host agent may comprise a mobile telephone equipped with a mobile application configured to submit new issues to the issue analysis and remediation system 102, receive notifications or alerts regarding issues submitted to the issue analysis and remediation system 102 (e.g., including responsive to the issue analysis and remediation system 102 generating one or more recommended categories or classifications for an issue, one or more remedial actions for resolving an issue, etc.). The given host agent provides an interface for responding to such various alerts or notifications as described elsewhere herein. This may include, for example, providing user interface features for selecting among different possible remedial actions. The remedial actions may include, for example, modifying the configuration of assets of the IT infrastructure 110, modifying access by client devices 104 to assets of the IT infrastructure 110, applying security hardening procedures, patches or other fixes to assets of the IT infrastructure 110, etc.

It should be noted that a “host agent” as this term is generally used herein may comprise an automated entity, such as a software entity running on a processing device. Accordingly, a host agent need not be a human entity.

The issue analysis and remediation system 102 in the FIG. 1 embodiment is assumed to be implemented using at least one processing device. Each such processing device generally comprises at least one processor and an associated memory, and implements one or more functional modules for controlling certain features of the issue analysis and remediation system 102. In the FIG. 1 embodiment, the issue analysis and remediation system 102 comprises an issue description semantic graph generation module 112, a system log state transition graph generation module 114, a machine learning-based issue classification module 116, and an issue remediation module 118.

The issue analysis and remediation system 102 is configured to obtain, for a given issue encountered during operation of one or more assets of the IT infrastructure 110, a description of user experience of the given issue and one or more system logs characterizing operation of the one or more assets of the IT infrastructure 110. The issue description semantic graph generation module 112 is configured to generate one or more semantic graphs characterizing the description of the given issue, and the system log state transition graph generation module 114 is configured to generate one or more state transition graphs characterizing a sequence of occurrence of one or more states of the operation of the one or more assets of the IT infrastructure 110.

The machine learning-based issue classification module 116 is configured to provide a combined representation of the one or more semantic graphs and the one or more state transition graphs for the given issue to a machine learning model (e.g., a graph convolutional neural network (CNN) or GCNN), and to identify one or more recommended classifications for the given issue based at least in part on an output of the machine learning model. The issue remediation module 118 is configured to initiate one or more remedial actions in the IT infrastructure 110 based at least in part on the one or more recommended classifications for the given issue. The remedial actions may include, but are not limited to, modifying the configuration of assets of the IT infrastructure 110, modifying access by client devices 104 to assets of the IT infrastructure 110, applying security hardening procedures, patches or other fixes to assets of the IT infrastructure 110, etc.

It is to be appreciated that the particular arrangement of the issue analysis and remediation system 102, client devices 104, issue database 108 and IT infrastructure 110 illustrated in the FIG. 1 embodiment is presented by way of example only, and alternative arrangements can be used in other embodiments. For example, the issue analysis and remediation system 102, or one or more portions thereof such as the issue description semantic graph generation module 112, the system log state transition graph generation module 114, the machine learning-based issue classification module 116, and the issue remediation module 118, may in some embodiments be implemented internal to one or more of the client devices 104 or the IT infrastructure 110. As another example, the functionality associated with the issue description semantic graph generation module 112, the system log state transition graph generation module 114, the machine learning-based issue classification module 116, and the issue remediation module 118 may be combined into one module, or separated across more than four modules with the multiple modules possibly being implemented with multiple distinct processors or processing devices.

At least portions of the issue description semantic graph generation module 112, the system log state transition graph generation module 114, the machine learning-based issue classification module 116, and the issue remediation module 118 may be implemented at least in part in the form of software that is stored in memory and executed by a processor.

It is to be understood that the particular set of elements shown in FIG. 1 for machine learning-based issue classification utilizing combined representations of semantic and state transition graphs for issues is presented by way of illustrative example only, and in other embodiments additional or alternative elements may be used. Thus, another embodiment may include additional or alternative systems, devices and other network entities, as well as different arrangements of modules and other components.

The issue analysis and remediation system 102 may be part of or otherwise associated with another system, such as a governance, risk and compliance (GRC) system, a security operations center (SOC), a critical incident response center (CIRC), a security analytics system, a security information and event management (SIEM) system, etc.

The issue analysis and remediation system 102, and other portions of the system 100, in some embodiments, may be part of cloud infrastructure as will be described in further detail below. The cloud infrastructure hosting the issue analysis and remediation system 102 may also host any combination of the issue analysis and remediation system 102, one or more of the client devices 104, the issue database 108 and the IT infrastructure 110.

The issue analysis and remediation system 102 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 104 and the issue analysis and remediation system 102 or components thereof (e.g., the issue description semantic graph generation module 112, the system log state transition graph generation module 114, the machine learning-based issue classification module 116, and the issue remediation module 118) may be implemented on respective distinct processing platforms, although numerous other arrangements are possible. For example, in some embodiments at least portions of the issue analysis and remediation system 102 and one or more of the client devices 104 are implemented on the same processing platform. A given client device (e.g., 104-1) can therefore be implemented at least in part within at least one processing platform that implements at least a portion of the issue analysis and remediation system 102. Similarly, at least a portion of the issue analysis and remediation system 102 may be implemented at least in part within at least one processing platform that implements at least a portion of the IT infrastructure 110.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for the issue analysis and remediation system 102, the client devices 104, the issue database 108 and the IT infrastructure 110, or portions or components thereof, to reside in different data centers. Numerous other distributed implementations are possible. The issue analysis and remediation system 102 can also be implemented in a distributed manner across multiple data centers.

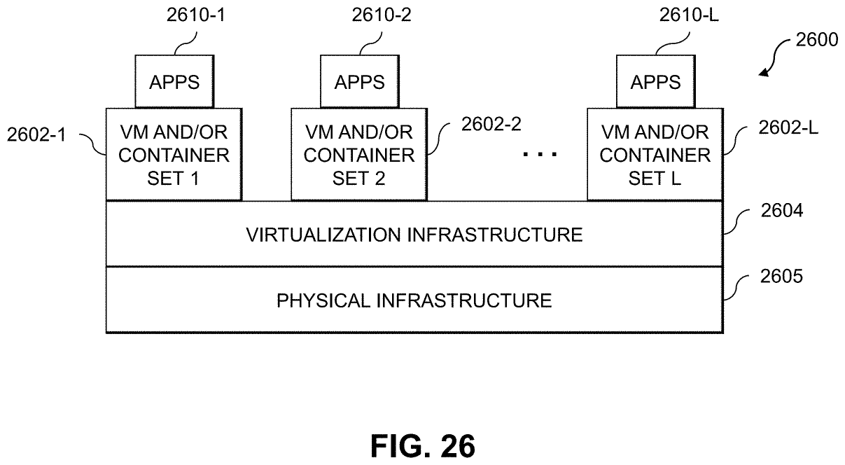

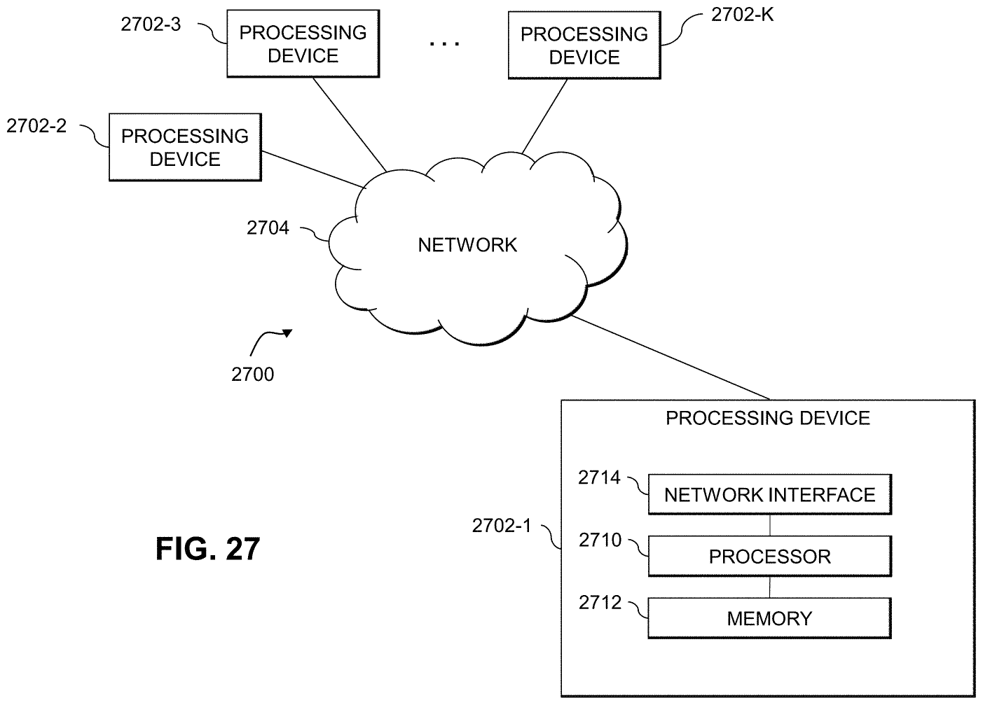

Additional examples of processing platforms utilized to implement the issue analysis and remediation system 102 in illustrative embodiments will be described in more detail below in conjunction with FIGS. 26 and 27.

It is to be appreciated that these and other features of illustrative embodiments are presented by way of example only, and should not be construed as limiting in any way.

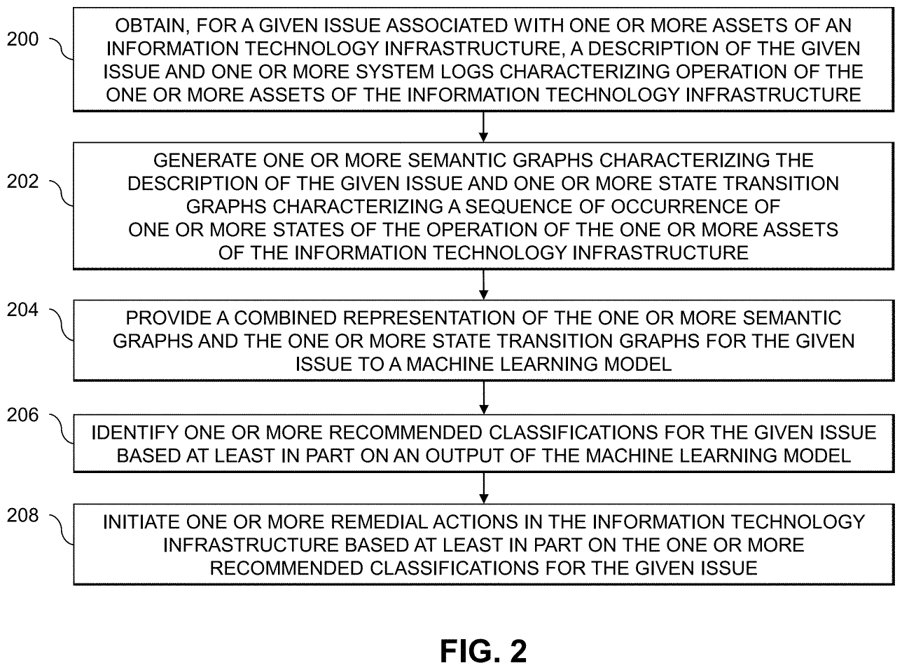

An exemplary process for machine learning-based issue classification utilizing combined representations of semantic and state transition graphs for issues will now be described in more detail with reference to the flow diagram of FIG. 2. It is to be understood that this particular process is only an example, and that additional or alternative processes for machine learning-based issue classification utilizing combined representations of semantic and state transition graphs for issues can be carried out in other embodiments.

In this embodiment, the process includes steps 200 through 208. These steps are assumed to be performed by the issue analysis and remediation system 102 utilizing the issue description semantic graph generation module 112, the system log state transition graph generation module 114, the machine learning-based issue classification module 116, and the issue remediation module 118. The process begins with step 200, obtaining, for a given issue associated with one or more assets of an IT infrastructure 110, a description of the given issue and one or more system logs characterizing operation of the one or more assets of the IT infrastructure 110.

In step 202, one or more semantic graphs characterizing the description of the given issue and one or more state transition graphs characterizing a sequence of occurrence of one or more states of the operation of the one or more assets of the IT infrastructure are generated. Step 202 may include performing preprocessing on the description of the given issue and the one or more system logs. The preprocessing may comprise at least one of: removing digits, punctuation and symbols; removing alphanumeric sequences; and removing identifiers.

A given one of the one or more semantic graphs may represent at least a subset of words of the description of the given issue as nodes with edges connecting the nodes representing placement of the words relative to one another in the description of the given issue. The given issue may be associated with a given domain, and one or more of the words in the subset of words of the description of the given issue may comprise terms from a domain-specific glossary of terms in a corpus defined for the given domain. Generating the given semantic graph may comprise assigning a part of speech category to each of the words in the subset of words of the description of the given issue.

A given one of the one or more state transition graphs may represent states of operation of the one or more assets of the information technology infrastructure as nodes with edges connecting the nodes representing a sequence of occurrence of the states of operation of the one or more assets of the information technology infrastructure. The given issue may be associated with a given domain, and the one or more of the states of operation of the one or more assets of the information technology infrastructure may comprise terms from a domain-specific glossary of states in a corpus defined for the given domain.

The process continues with step 204, providing a combined representation of the one or more semantic graphs and the one or more state transition graphs for the given issue to a machine learning model in step 204. One or more recommended classifications for the given issue are identified in step 206 based at least in part on an output of the machine learning model. In step 208, one or more remedial actions are initiated in the IT infrastructure based at least in part on the one or more recommended classifications for the given issue. The one or more remedial actions may comprise modifying a configuration of the one or more assets of the IT infrastructure 110.

The machine learning model may comprise a graph convolutional neural network (CNN) or GCNN. The GCNN may comprise two or more hidden layers, a first one of the two or more hidden layers having a structure determined based at least in part on a number of vertices in the combined representation of the one or more semantic graphs and the one or more state transition graphs for the given issue, a second one of the two or more hidden layers having a structure determined based at least in part on a number of possible classification labels for the given issue. The combined representation of the one or more semantic graphs and the one or more state transition graphs for the given issue may comprise a feature matrix and an adjacency matrix, the feature matrix comprising an identity matrix with elements representing vertices of the one or more semantic graphs and the one or more state transition graphs, the adjacency matrix comprising elements representing whether pairs of vertices of the one or more semantic graphs and the one or more state transition graphs are adjacent to one another.

In some embodiments, the FIG. 2 process also includes training the machine learning model utilizing combined representations of one or more historical semantic graphs and one or more historical state transition graphs generated for one or more historical issues associated with the assets of the information technology infrastructure. The representations of the one or more historical issues associated with assets of the information technology infrastructure may comprise: a feature matrix comprising an identity matrix with elements representing vertices of the one or more historical semantic graphs and the one or more historical state transition graphs generated for the one or more historical issues; an adjacency matrix comprising elements representing whether pairs of vertices of the one or more historical semantic graphs and the one or more historical state transition graphs are adjacent to one another; and a label matrix comprising elements representing classification labels for the one or more historical issues.

Issue diagnosis and proactive remediation is an important aspect for various IT infrastructure, including technology-enabled systems and products (e.g., both hardware and software). From a user point of view, for example, issue analysis is important for managing IT infrastructure. The assets of IT infrastructure (e.g., physical and virtual computing resources of the IT infrastructure) may generate large amounts of information in the form of application or system logs, which can be used by an issue analysis and remediation system such as system 102. In illustrative embodiments, smart and intelligent issue analysis and remediation systems are provided that are capable of understanding the domain context of a system or product (or, more generally, assets of an IT infrastructure) combined with actual runtime activities of the system or product. Advantageously, the smart and intelligent issue analysis and remediation systems are configured to generate a wholistic graphical representation of the issues at hand, and utilize the wholistic graphical representation for deep learning analysis. Such deep learning analysis may be used for classifying issues (e.g., predicting issue similarity to past historical issues) and for recommending actions for remediating the classified issues.

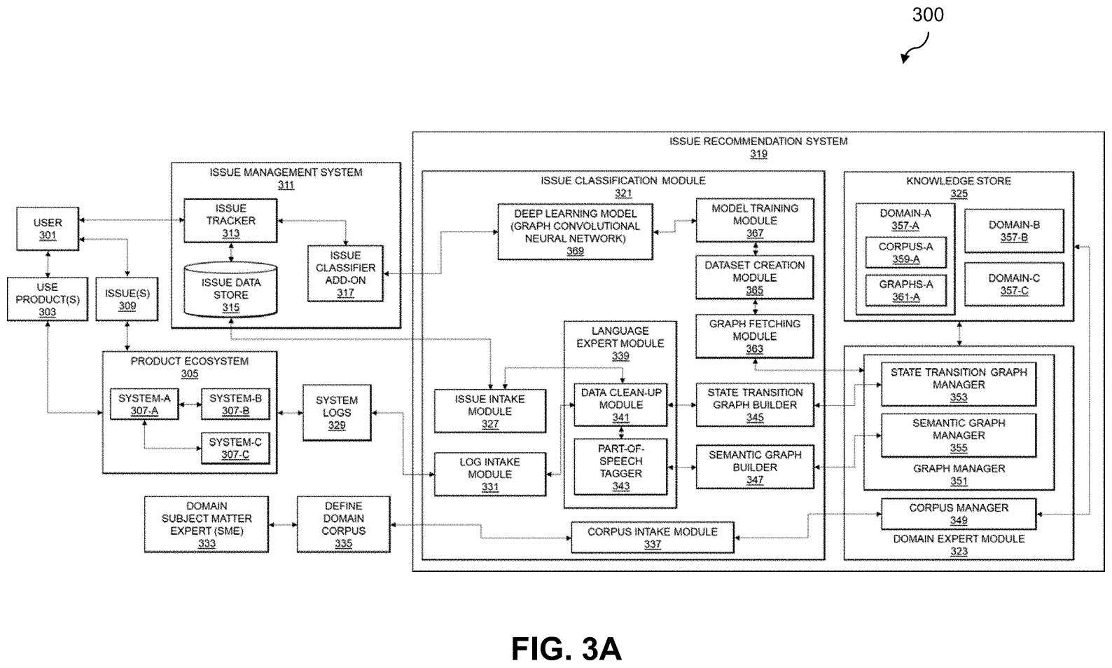

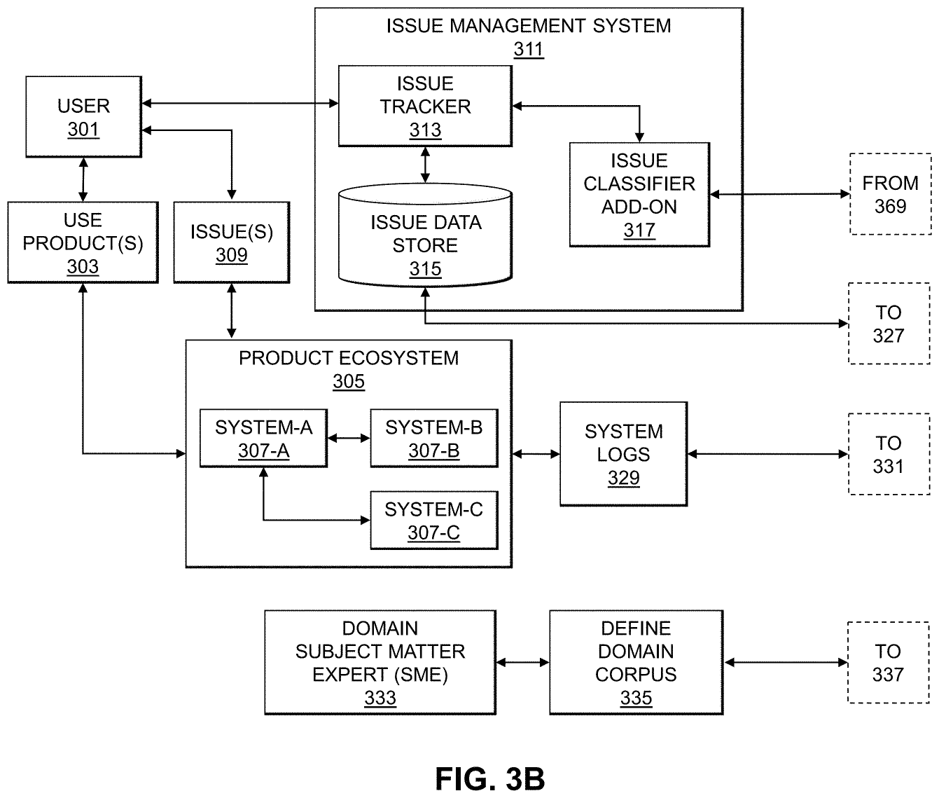

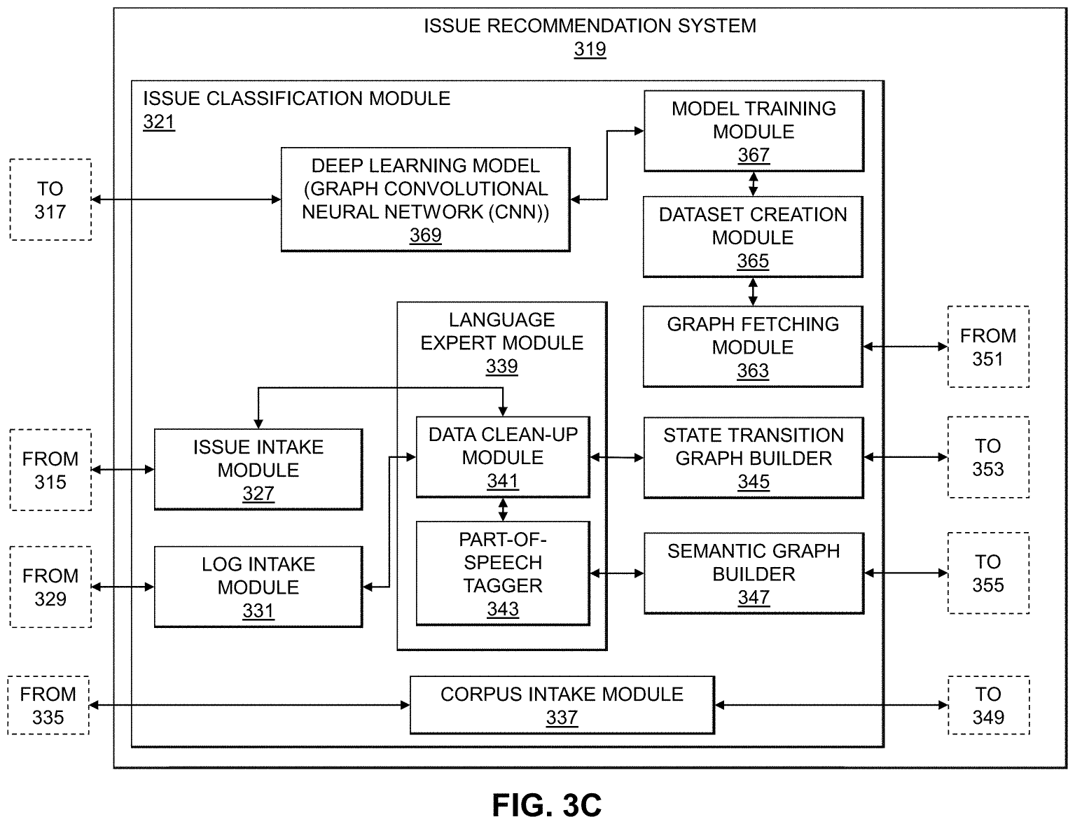

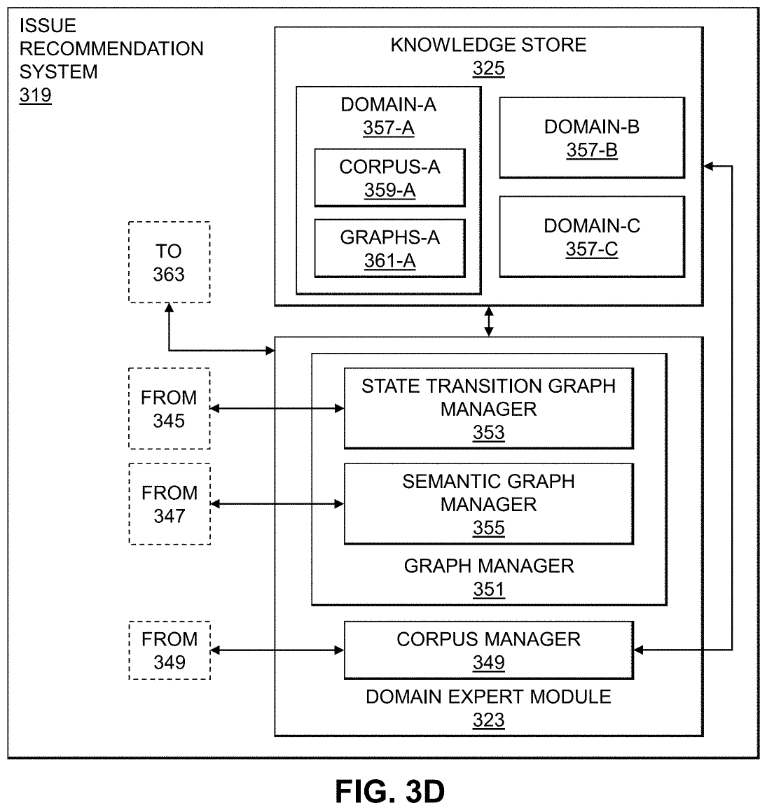

FIGS. 3A-3D show a smart intelligent issue analysis system 300 configured for domain-driven issue analysis. FIG. 3A shows an overall view of the system 300, and FIGS. 3B-3D show more detailed views of portions of the system 300 shown in FIG. 3A. The system 300 includes a user 301 that uses various products 303 of a product ecosystem 305. The product ecosystem 305 includes various systems 307 that are interrelated (e.g., system-A 307-A, system-B 307-B and system-C 307-C). In conjunction with use of the products 303 of the product ecosystem 305, various issues 309 are encountered by the user 301. The user 301 submits such issues 309 to an issue management system 311. More particularly, the user 301 may submit such issues 309 to an issue tracker 313 of the issue management system 311. The issue tracker 313 illustratively stores such issues in an issue data store 315. The issue management system 311 further includes an issue classifier add-on 317, which interacts with an issue recommendation system 319.

The issue recommendation system 319 includes an issue classification module 321, a domain expert module 323 and a knowledge store 325. The issue classification module 321 includes an issue intake module 327, which obtains issues 309 from the issue data store 315 and provides the issues 309 to a language expert module 339. The issue classification module 321 also includes a log intake module 331, which obtains system logs 329 produced by the systems 307 of the product ecosystem 305 and provides the system logs 329 to the language expert module 339. The issue classification module 321 further includes a corpus intake module 337. A domain subject matter expert (SME) 333 is assumed to define domain corpuses 335 using the corpus intake module 337, with the domain corpuses 335 being provided to a corpus manager 349 of the domain expert module 323. The corpus manager 349 illustratively stores the domain corpuses 335 as domains 357 (e.g., domain-A 357-A for system-A 307-A, domain-B 357-B for system-B 307-B, domain-C 357-C for system-C 307-C) in the knowledge store 325. As shown in FIG. 3A, the domain-A 357-A stores corpus-A 359-A for the domain corpus defined by the domain SME 333 for domain-A 357-A. Although not explicitly shown in FIGS. 3A-3D, it is assumed that corpuses are also stored for domain-B 357-B and domain-C 357-C.

The language expert module 339 illustratively includes a data clean-up module 341 and a part-of-speech tagger 343. The data clean-up module 341 obtains the issues 309 from the issue intake module 327 and the system logs 329 from the log intake module 331, and performs various preprocessing on the issues 309 and system logs 329. The language expert module 339 utilizes ingestion modules (e.g., the issue intake module 327 and log intake module 331) to read end user reported issues and application or system logs. The data clean-up module 341 performs various pre-processing on the reported issues 309 and application or system logs 329. Such pre-processing may include: removing digits, punctuation and symbols; removing alphanumeric characters; removing identifiers (IDs) or autogenerated identifiers (e.g., globally unique IDs (GUIDs)). The part-of-speech tagger 343 leverages a Natural Language Tool Kit (NLTK) package and assigns one of the parts of speech to each word in a sentence (e.g., as nouns, verbs, adverbs, adjectives, pronouns, conjunction, sub-categories thereof, etc.). The language expert module 339 may also include a lemmatizer (e.g., leveraging spaCy or another suitable lemmatizer package) to extract keywords or commonly used terms and respective subjects (e.g., in a given domain by looking up the domain corpus for the given domain from the knowledge store 325). The language expert module 339 may use a corpus loader to fetch required domain corpuses used in the lemmatizer. The corpus loader may also publish the latest new states extracted from application or system logs 329 (e.g., on-demand) to the state corpus of a given domain stored in the knowledge store 325. The language expert module 339 may also provide an interface for retrieving domain and state corpuses from the knowledge store 325 and facilitating domain and state corpus updates back to the knowledge store 325 (e.g., on-demand).

The data clean-up module 341 provides the pre-processed system logs 329 to a state transition graph builder 345 to generate state transition graphs for the issues 309. The state transition graph builder 345 provides the generated state transition graphs to a graph manager 351 of the domain expert module 323. More particularly, the generated state transition graphs are provided to a state transition graph manager 353. The data clean-up module 341 provides the pre-processed issues 309 to the part-of-speech tagger 343. The part-of-speech tagger 343 then provides the pre-processed and tagged issues 309 to a semantic graph builder 347 to generate semantic graphs for the issues 309. The semantic graph builder 347 provides the generated semantic graphs to the graph manager 351 of the domain expert module 323. More particularly, the generated semantic graphs are provided to a semantic graph manager 355. The graph manager 351 stores the generated state transition graphs and semantic graphs in the knowledge store 325 utilizing the state transition graph manager 353 and semantic graph manager 355. As shown in FIG. 3A, for example, domain-A 357-A includes graphs-A 361-A (e.g., state transition graphs and semantic graphs generated for issues 309 and system logs 329 associated with domain-A 357-A). Although not shown for clarity, it is assumed that graphs are also generated and stored in the knowledge store 325 for domain-B 357-B and domain-C 357-C.

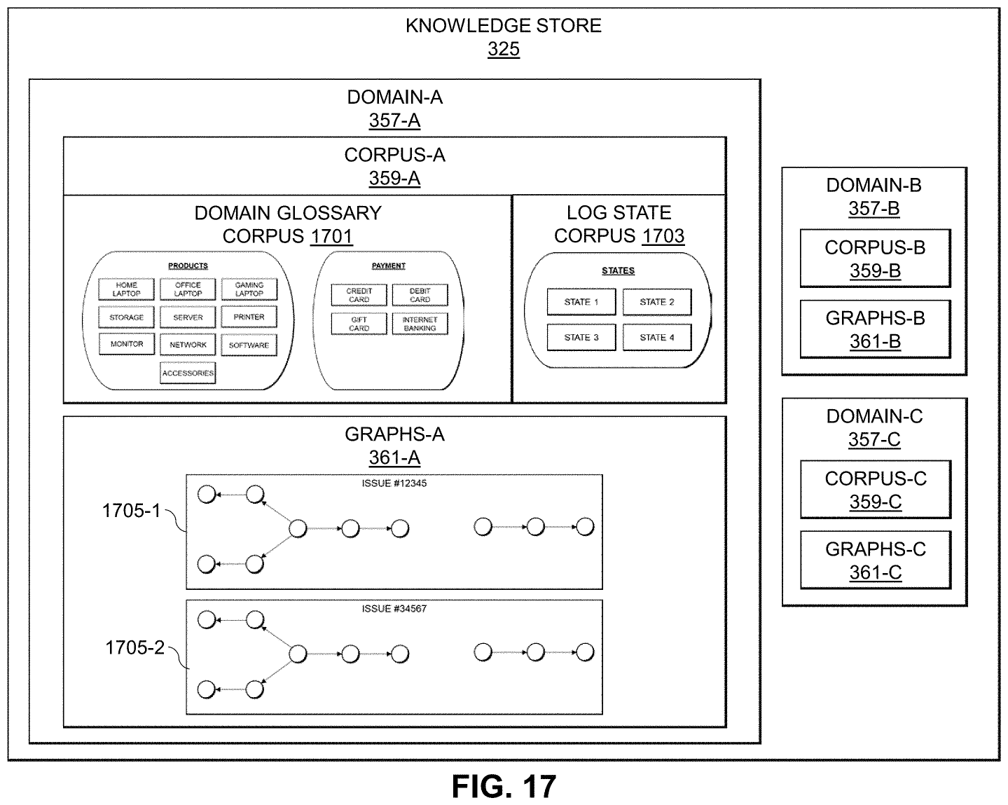

The knowledge store 325, in some embodiments, is implemented as a graph database store (e.g., built using a Neo4j database) that stores data in the form of nodes and relationships. The knowledge store 325 is configured to handle both transactional and analytics workloads, and may be optimized for traversing paths through the data using the relationships in the graphs to find connections between entities. For each domain (e.g., for each of domain-A 357-A, domain-B 357-B, domain-C 357-C), the knowledge store 325 stores information in two different groups—corpus and graphs. For example, FIGS. 3A-3D show domain-A 357-A stores corpus-A 359-A and graphs-A 361-A. Although not shown, the other domains (e.g., domain-B 357-B and domain-C 357-C) are also assumed to store both corpus and graphs for their corresponding domains. The corpus (e.g., corpus 359-A) provides both a glossary of terms for each subject used for building semantic graphs, and the states used for generating state transition graphs. The graphs (e.g., graphs 361-A) include both semantic graphs and state transition graphs, where each user-reported issue and corresponding application or system log information is represented as a semantic graph and a state transition graph. FIG. 17, discussed below, provides an illustration of information stored in the knowledge store 325.

The domain expert module 323 includes the corpus manager 349 and a graph manager 351 for facilitating interactions with the knowledge store 325. The corpus manager 349 is configured to retrieve and store the corpus of different domains (e.g., domain-A 357-A, domain-B 357-B, domain-C 357-C) provided by domain SMEs 333 as well as state information captured by the language expert module 339 from the system logs 329. The graph manager 351 provides both the state transition graph manager 353 and semantic graph manager 355 for retrieving and storing information related to state transition graphs and semantic graphs generated by the state transition graph builder 345 and semantic graph builder 347 of the issue classification module 321. The domain expert module 323, in some embodiments, leverages a graph query language (e.g., the Cypher graph query language) to read and write data to the graphs stored in knowledge store 325. By leveraging a graph query language such as Cypher, it makes it easier for the domain expert module 323 to construct expressive and efficient queries to handle needed create, read, update and delete functionality.

The issue classification module 321 further includes a graph fetching module 363, a dataset creation module 365, a model training module 367, and a deep learning model 369. The graph fetching module 363 is configured to obtain state transition graphs and semantic graphs from the graph manager 351. The dataset creation module 365 is configured to generate final graphs for particular ones of the issues 309 from combinations of the state transition and semantic graphs. The dataset creation module 365 is also configured to convert the final graphs into a format suitable for input to the deep learning model 369. The model training module 367 trains the deep learning model 369 using the datasets created by dataset creation module 365. The deep learning model 369, which in some embodiments is implemented using a GCNN, then performs classification of issues for the issue management system 311. The issue classification recommendations produced by the deep learning model 369 are provided to the issue classifier add-on 317 of the issue management system 311, and then to the issue tracker 313. The issue classifications are used to recommend remedial actions for resolving the issues (e.g., based on successful remediation actions applied to historical issues with the same or similar classifications).

The system 300, as shown in FIGS. 3A-3D, includes the issue recommendation system 319 with an issue classification module 321, domain expert module 323, knowledge store 325 and language expert module 339. Issue analysis and proactive recommendation for any given domain is a complex process, involving various phases such as information gathering (e.g., of various types such as a domain glossary, issues reported by users, application logs of various ecosystems participating within the domain, etc.), refinement of gathered information, transformation of extracted information into a digital format, storage management, inference of digital information, and recommendation of an issue category for any new issue occurrence. The issue classification module 321 of the issue recommendation system 319 enables the planning and execution of these various phases required for issue analysis, thereby expediting proactive remediation by recommending the relevant issue category for an unclassified issue based on historical occurrence and classification of similar issues.

The process of issue analysis remediation may involve information collected from various stakeholders and ecosystems, including: the domain SMEs 333; end users including user 301; developers; etc. The domain SMEs 333 describe the products (e.g., of product ecosystem 305, including system-A 307-A, system-B 307-B and system-C 307-C) and system-related glossaries of terms commonly used in one or more domains (e.g., domain-A 357-A, domain-B 357-B, domain C 357-C). End users such as user 301 provide issues 309 describing their experience and evidence of challenges faced while using products and systems of the product ecosystem 305, such as by providing information including steps followed, transaction reference identifiers, system error messages encountered, etc. The developers (e.g., of system-A 307-A, system-B 307-B and system-C 307-C of the product ecosystem 305) embed log instrumentation at significant stages of source code, so as to ease troubleshooting of issues with commonly used terms in the domains (e.g., domain-A 357-A, domain-B 357-B, domain C 357-C) and transaction identifiers.

Such information is illustratively captured in plain language (e.g., plain English), both in natural and formal fashion. The language expert module 339 of the issue classification module 321 is configured to cleanse the information, and extract parts related to various categories in accordance with linguistic grammar syntactic functions. The language expert module 339 advantageously ensures that the main intent of the given information is preserved, and passes it to the issue classification module 321 for conversion into a digital format.

The knowledge store 325 of the issue recommendation system 319 is configured to provide storage for persisting the information in digital format. The digital format, in some embodiments, is configured to capture significant aspects of the user experience and log information that preserves hierarchical dependencies and complex paths. The knowledge store 325 has logical partitions to manage the storage of the digital information along with associated corpus. For example, as shown in FIGS. 3A-3D, the knowledge store 325 stores for domain-A 357-A both corpus-A 359-A and graphs-A 361-A.

The domain expert module 323 of the issue recommendation system 319 provides configuration management for the knowledge store 325. The domain expert module 323 also provides an adapter for managing remote concurrent connections with the knowledge store 325 for adding digital information in bulk under a corresponding domain-specific partition. The domain expert module 323 is also configured to support native querying techniques for facilitating information retrieval from the knowledge store 325.

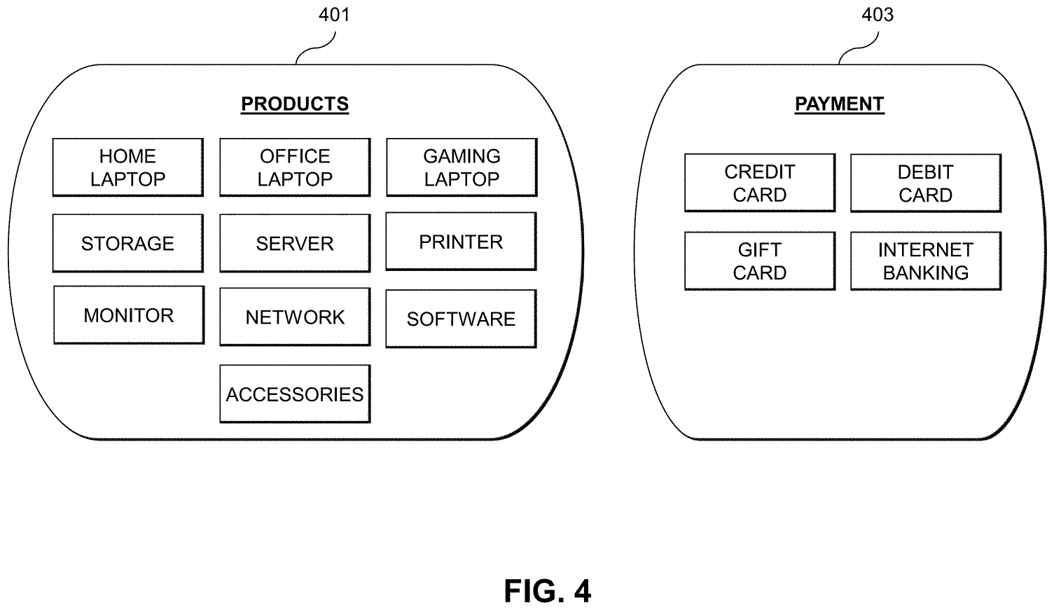

Functionality related to building semantic graphs will now be described with respect to FIGS. 4-8. The issue recommendation system 319 includes various ingestion components (e.g., the issue intake module 327, the log intake module 331 and the corpus intake module 337). FIG. 4 shows examples of glossaries of terms that are provided by the domain SMEs 333 to the corpus intake module 337 for a particular domain (e.g., one of domain-A 357-A, domain-B 357-B, domain-C 357-C), specifically a product glossary 401 and a payment glossary 403. The product glossary 401 and payment glossary 403, as illustrated in FIG. 4, show examples of terms for products and payments within a particular domain (e.g., a sales domain). Such terms may be provided as a domain glossary for a corpus (e.g., corpus-A 359-A). The corpus (e.g., corpus-A 359-A) may also store a glossary of log states.

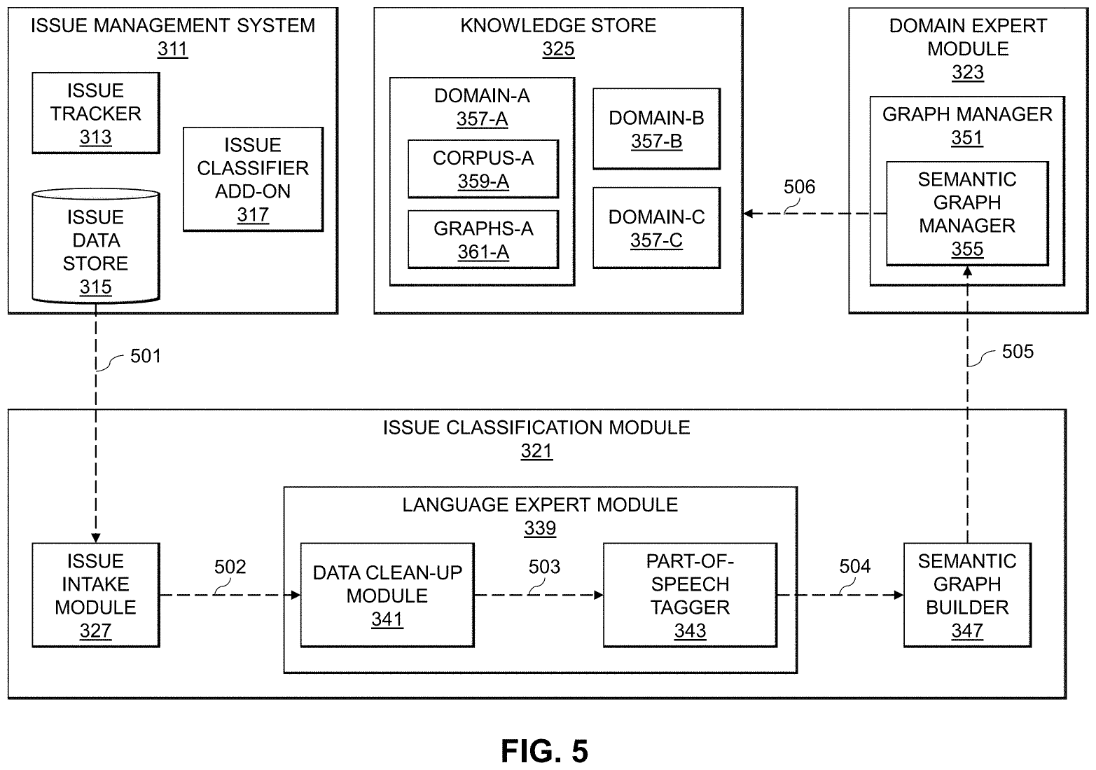

FIG. 5 illustrates a flow for the issue classification module 321 of the issue recommendation system 319 to ingest historical issues from the issue data store 315 of issue management system 311 by the issue intake module 327. In step 501, the issue intake module 327 ingests the historical issues for a given domain (e.g., domain-A 357-A) from the issue data store 315. The issues are provided from the issue intake module 327 to the data clean-up module 341 of the language expert module 339 in step 502. The data clean-up module 341 cleans up the issue descriptions, and provides the cleaned-up issue descriptions to the part-of-speech tagger 343 in step 503. The part-of-speech tagger 343 tags identified words of interest in the cleaned-up issue descriptions, and passes the tagged issue descriptions to the semantic graph builder 347 in step 504. The semantic graph builder 347 builds semantic graphs for the issues using the words of interest, based on their associated type and placement in a sentence. The semantic graph also includes nodes and words from an associated domain corpus for the domain of a particular issue. The semantic graph builder 347 provides the generated semantic graphs to the semantic graph manager 355 in step 505. The semantic graph manager 355 stores the semantic graphs in the knowledge store 325 (e.g., as graphs-A 361-A for domain-A 357-A) in step 506, for later use in training and issue analysis as described elsewhere herein.

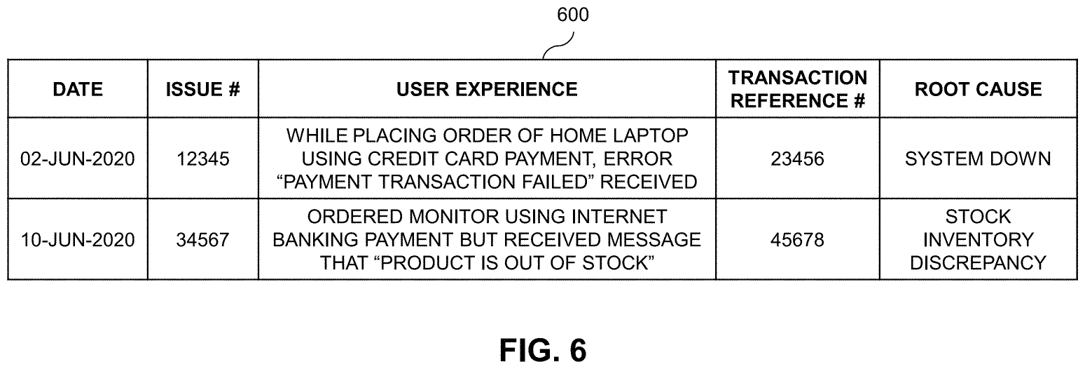

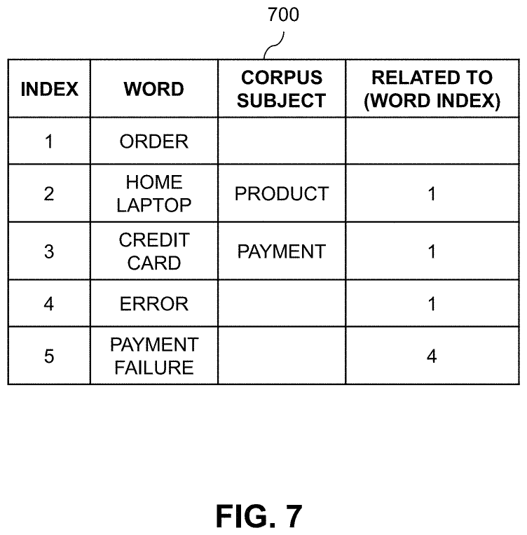

FIG. 6 shows a table 600 of examples of issues reported by end users (e.g., such as user 301) to the issue management system 311 regarding the end users' experience while using systems or products in the product ecosystem 305. A reported issue advantageously details the sequence of events that have occurred, and final unexpected behavior of a product or system. Each reported issue may be associated with a transaction reference number as evidence. Once a reported issue is resolved by a relevant technical or functional team, a root cause may also be captured in the issue details. FIG. 7 shows a table 700 illustrating clean-up of the first issue of table 600 (e.g., the first row thereof for issue number 12345). More particularly, the table 700 illustrates domain keywords that are extracted, along with the subject and dependencies between the extracted keywords.

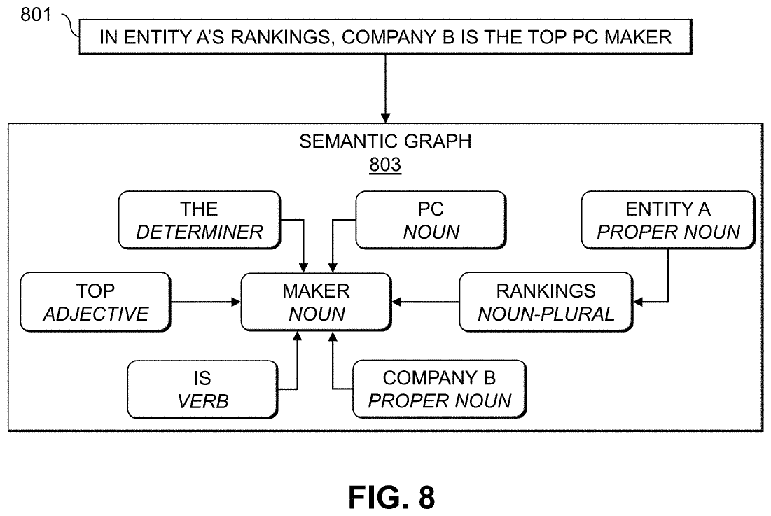

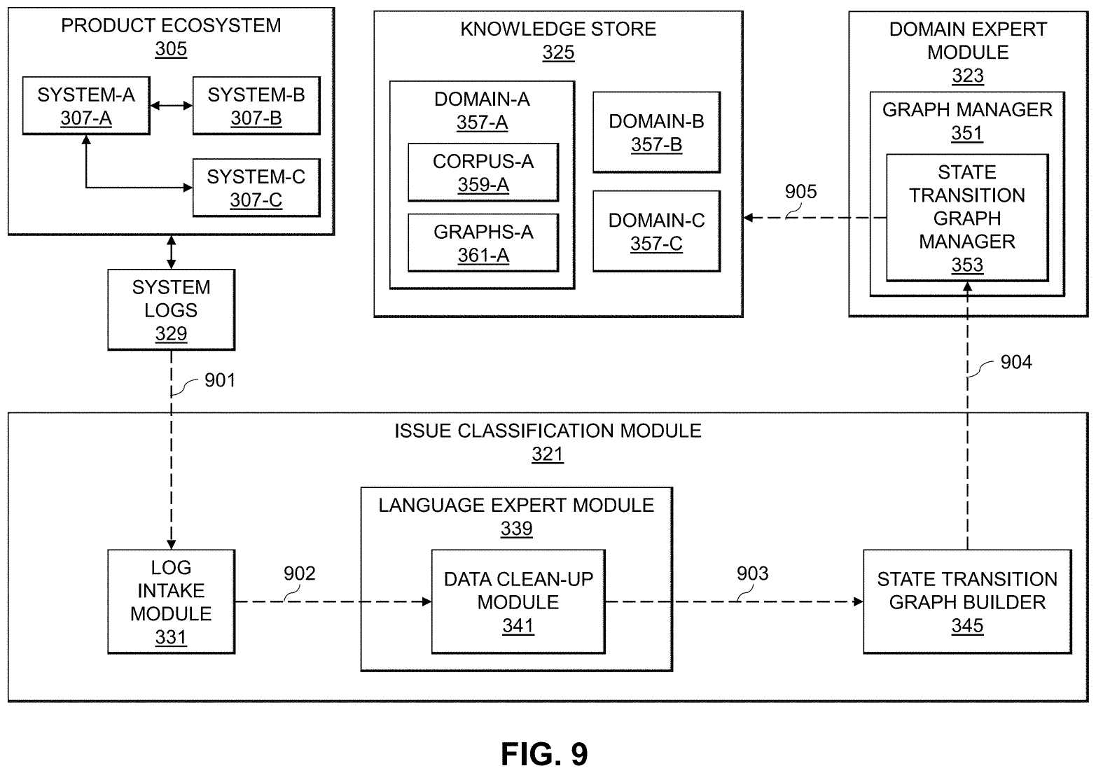

FIG. 8 shows an example sentence 801, and a semantic graph 803 generated therefrom. Semantic graphs are a form of abstract syntax in which an expression of a natural language is represented as a graphical structure whose vertices are the expression's terms (words) and edges represent the relations between terms. Semantic graphs are generated from an issue created by an end user (e.g., user 301) of a system or product (e.g., in product ecosystem 305) in a natural language.

Functionality related to building state transition graphs will now be described with respect to FIGS. 9-12. FIG. 9 illustrates a flow for the issue classification module 321 of the issue recommendation system 319 to ingest system logs 329 from products and systems of the product ecosystem 305 by the log intake module 331. In step 901, the log intake module 331 obtains the system logs 329 that are associated with each reported issue. The log intake module 331 provides the system logs 329 to the data clean-up module 341 of the language expert module 339 in step 902. The data clean-up module 341 cleans up the system logs 329, and identifies various states involved for different issues. The cleaned-up system logs 329 are provided to the state transition graph builder 345 in step 903. The state transition graph builder 345 generates states transition graphs using states as nodes and edges connecting the nodes based on their associated sequence of occurrence (e.g., transitions between the states). The state transition graph builder 345 provides the generated state transition graphs to the state transition graph manager 353 in step 904. The state transition graph manager 353 stores the state transition graphs in the knowledge store 325 (e.g., as graphs-A for domain-A 357-A) in step 905, for later use in training and issue analysis as described elsewhere herein.

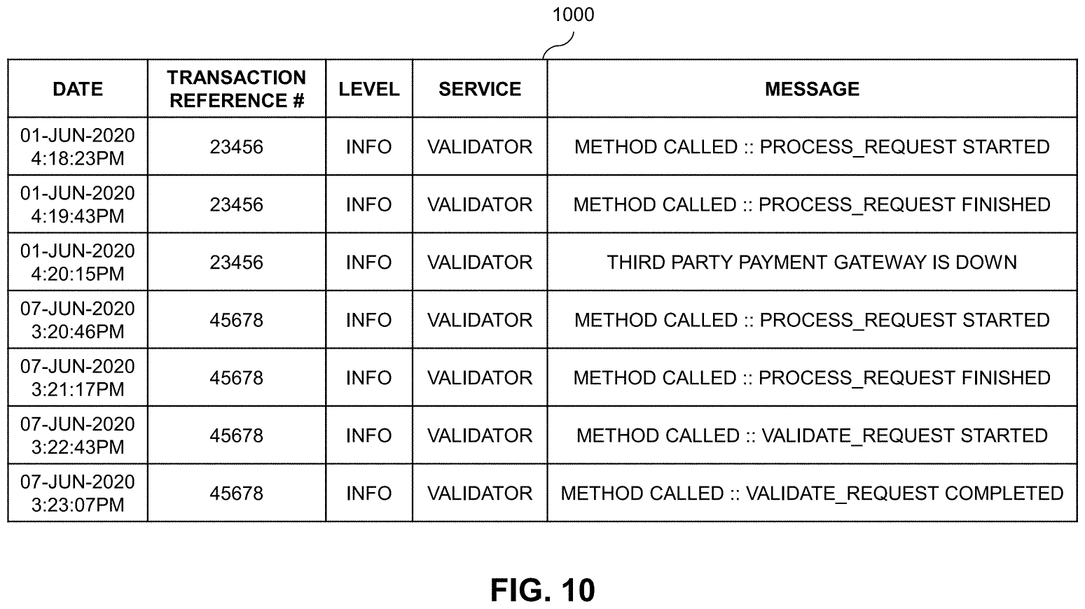

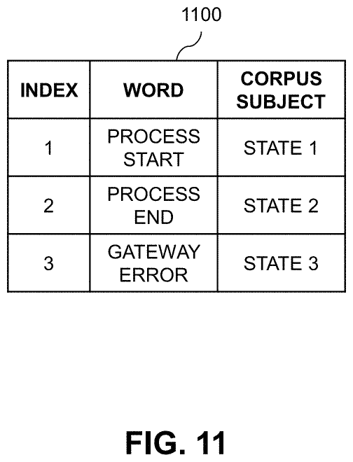

FIG. 10 illustrates a table 1000 of application logs (e.g., generated by various products and systems in the product ecosystem 305 as application or system logs 329 in transactions of different domains). An application log may include, for example, a date, a transaction reference number, a level, a service name, and a message. FIG. 11 shows a table 1100 illustrating clean-up of a first issue of table 1000 (e.g., the first three rows thereof with transaction reference number 23456). More particularly, the table 1100 illustrates various stages or states involved in the transaction and a sequence in which the stages have occurred represented by the index numbers.

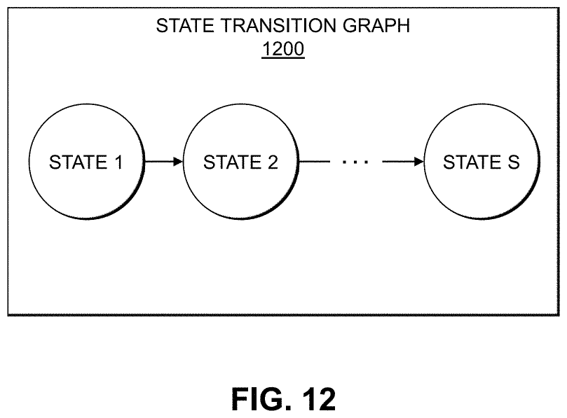

State transition graphs provide a mathematical way to study the behavior of a system, by denoting the workflow of a system from one state to another in a graphical format. For example, each of the system logs 329 generated by the product ecosystem 305 may denote a state of a given transaction. The state transition graphs are generated by embedding these states as vertices and the sequence of their occurrence as relations between the vertices. FIG. 12 shows an example of a state transition graph 1200.

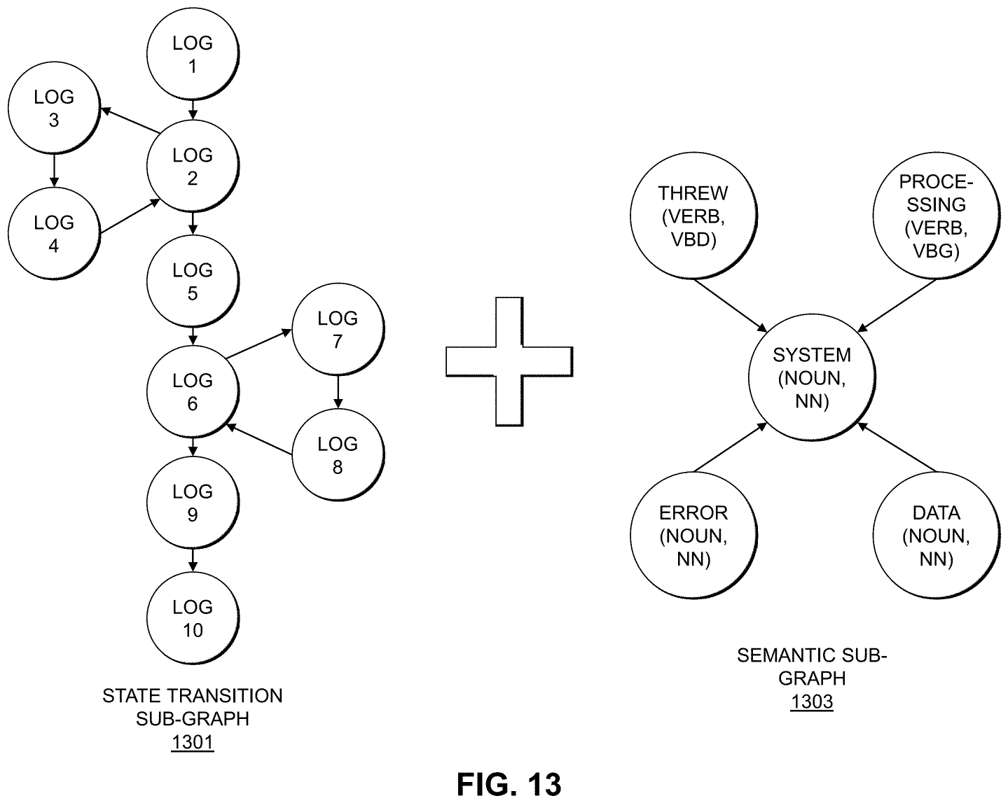

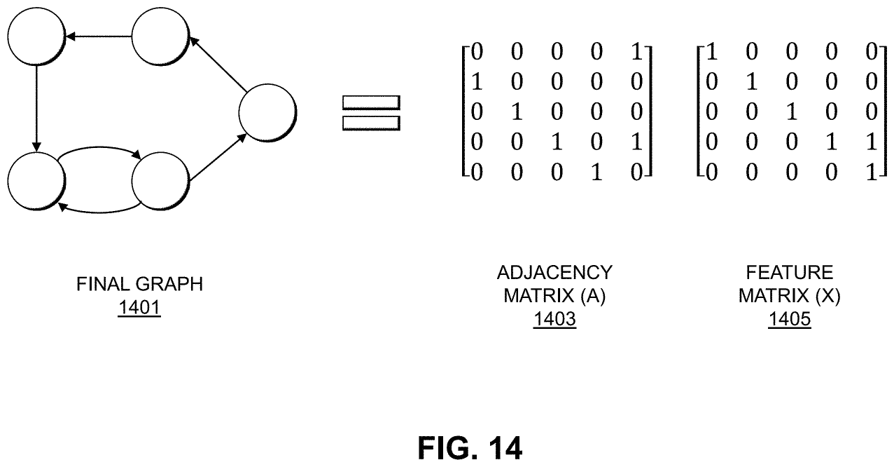

Functionality related to building final graphs from semantic graphs and state transition graphs will now be described with respect to FIGS. 13-16. FIG. 13 illustrates combination of a state transition sub-graph 1301 and a semantic sub-graph 1303 to form a final graph. The final graph is a network graph representation of an issue, which captures both the domain context as well as the application execution flow context. FIG. 14 shows a final graph 1401, which may be broken down into an adjacency matrix (A) 1403 and a feature matrix (X) 1405. The adjacency matrix A 1403 of the final graph 1401 is forward-fed to a deep learning based predictive model as described in further detail below with respect to FIG. 17.

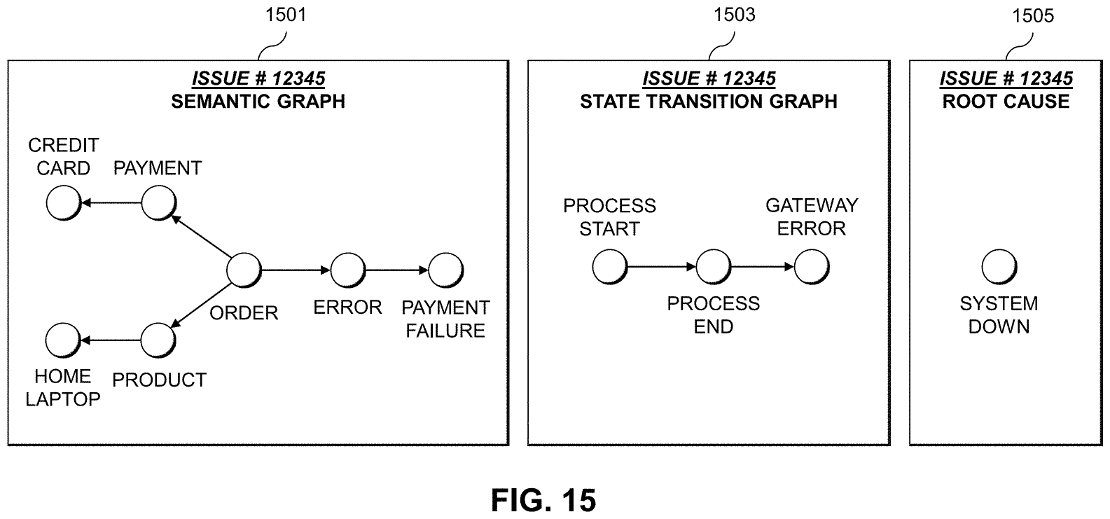

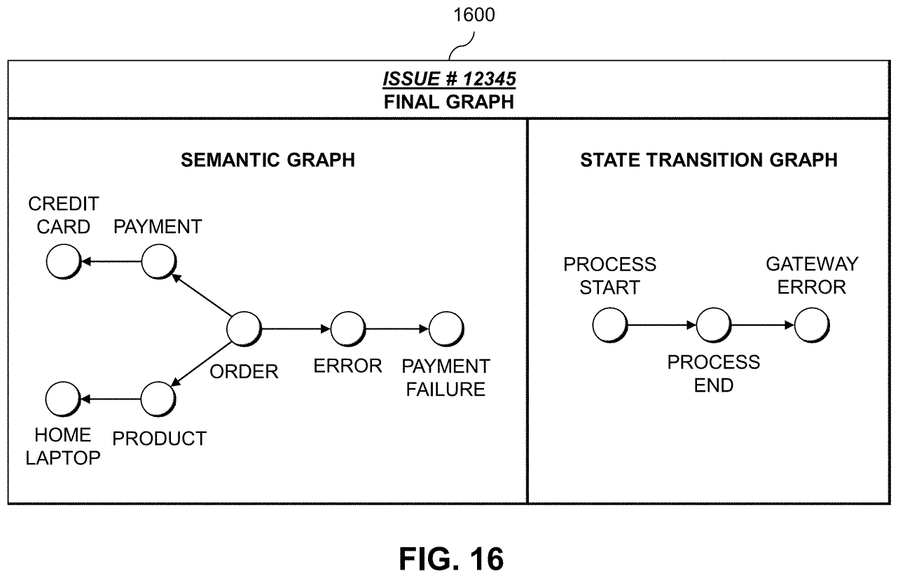

FIG. 15 shows an example of a semantic graph 1501, a state transition graph 1503 and a root cause 1505 for one of the issues (e.g., issue #12345 and transaction reference #23456 in the tables 600 and 1000 described above). FIG. 16 shows an example final graph 1600 formed by combining the semantic graph 1501 and state transition graph 1503.

FIG. 17 shows an example of information stored in the knowledge store 325. In the FIG. 17 example, the domain-A 357-A is assumed to be a sales domain, and the corpus-A 359-A includes domain glossary corpus 1701 for products and payments as well as a log state corpus 1703 of states for the sales domain. The graphs-A 361-A includes semantic graphs and state transition graphs for different reported issues in the sales domain. For example, semantic and state transition graphs 1705-1 and 1705-2 are shown for issue reference numbers 12345 and 34567 of table 600. FIG. 17 also shows the corpus-B 359-B and graphs-B 361-B for domain-B 357-B, and the corpus-C 359-C and graphs-C 361-C for domain-C 357-C.

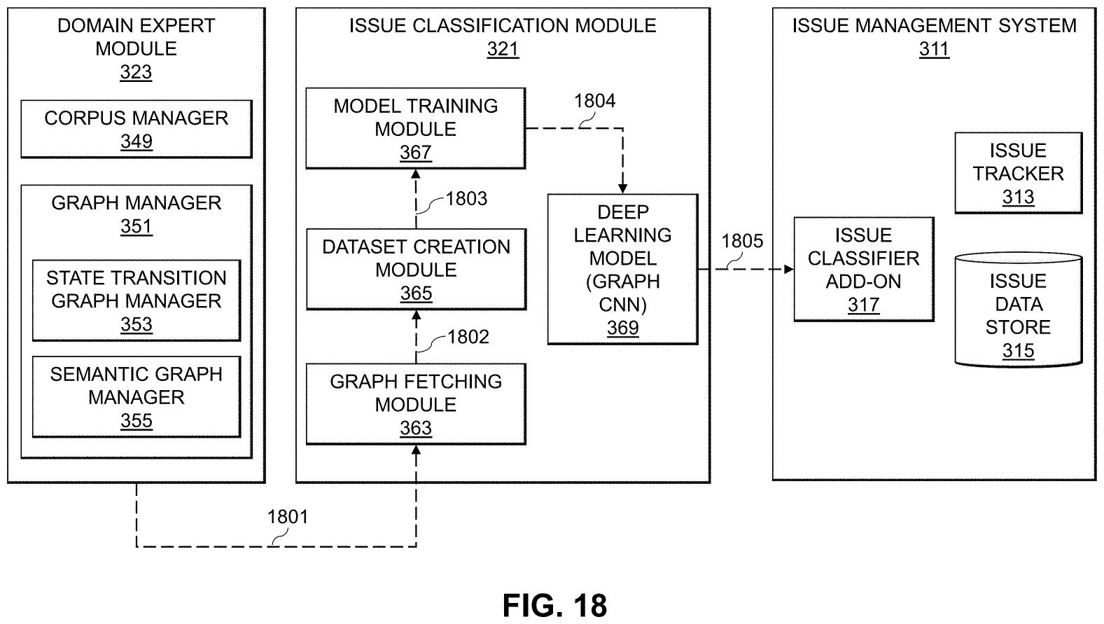

Functionality for training the deep learning model 369 of the issue classification module 321 will now be described with respect to FIGS. 18-20. FIG. 18 illustrates a flow for the issue classification module 321 of the issue recommendation system 319 to train the deep learning model 369. The domain expert module 323, as noted above, includes corpus manager 349 and graph manager 351. The corpus manager 349 persists corpus information for different domains in the knowledge store 325, while the graph manager 351 (e.g., via state transition graph manager 353 and semantic graph manager 355) persists state transition graphs and semantic graphs for different domains in the knowledge store 325. Root cause information may also be stored in the knowledge store 325. The graph fetching module 363 fetches semantic graphs, state transition graphs and root causes from the knowledge store 325 using interfaces provided by the domain expert module 323 in step 1801. In some embodiments, the graph fetching module 363 fetches such information for each issue reported by end users, and provides such information to the dataset creation module 365 in step 1802.

For training and analysis, the graph fetching module 363 invokes the domain expert module 323 to fetch such information and to generate final graphs therefrom on demand, where the final graphs are combinations of both system experience and user experience in a single structure to be used for training the deep learning module 369. In some embodiments, the final graphs may be stored in the knowledge store 325, and are themselves fetched by the graph fetching module 363 in step 1801 (e.g., instead of the graph fetching module 363 generating the final graphs on demand). The final graphs and labels for each historical issue for a particular domain are used for training the deep learning model 369. In step 1802, the final graphs and labels are provided to dataset creation module 365 for preparing datasets required for training. In some embodiments, the datasets required for training include three matrices—a feature matrix (X), a label matrix (L) and an adjacency matrix (A). The feature matrix is an identity matrix created using the vertices (nodes) of the final graph. The label matrix indicates the root cause class or category of a given issue. The adjacency matrix is generated by collating the final graphs of all reported issues in the past and represents the same as elements of the adjacency matrix indicating whether pairs of vertices are adjacent or not in the final graph.

In step 1803, the datasets are provided to the model training module 367. The model training module 367 utilizes the datasets to train the deep learning model 369. This may include training the deep learning model 369 in step 1804 to “look” at each issue and learn which label fits best for what issue. For analysis, the deep learning model 369 for a particular domain is used to generate label recommendations in step 1805 to pass to the issue management system 311. In some embodiments, the deep learning model 369 used is a GCNN model. The GCNN model consumes the adjacency matrix (A) of the final graph and an identity matrix (I) for the feature matrix (X) as an input. The expected output for training will be the pre-defined label classes (L). The structure of the final graph and L will be unique for each domain.

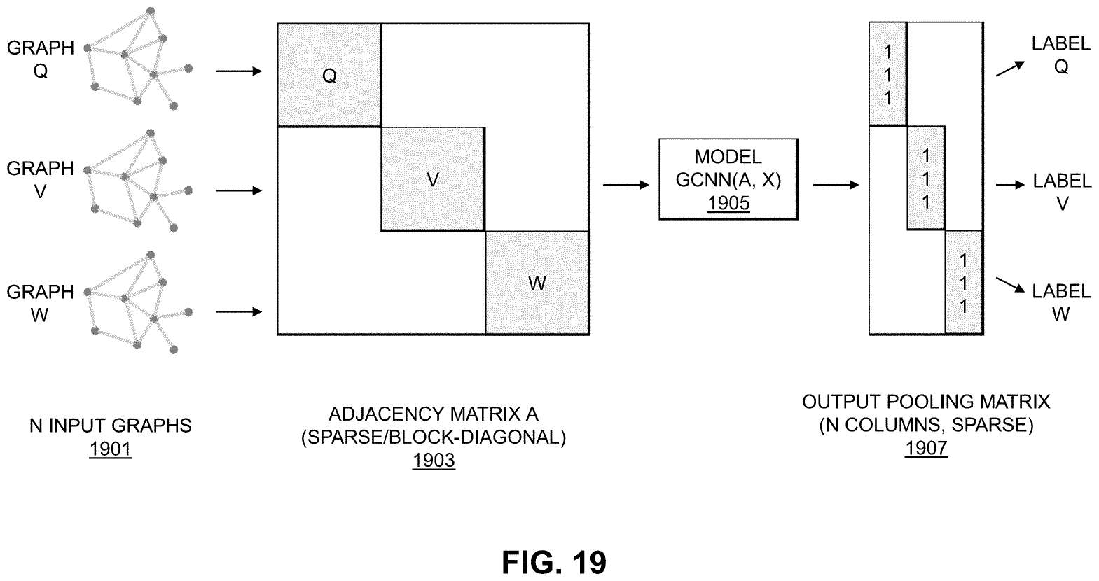

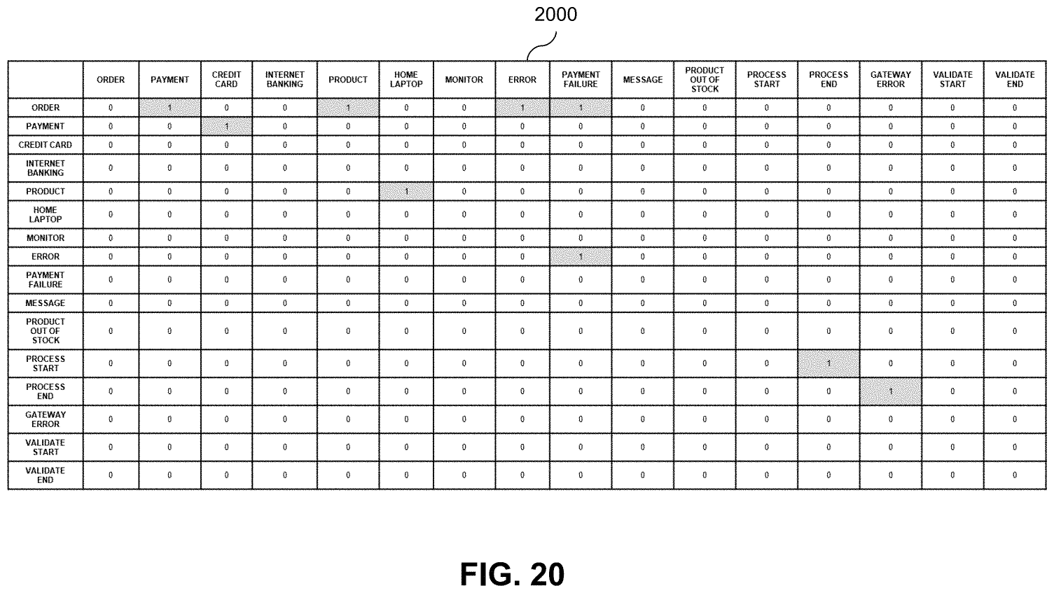

The training of the deep learning model 369 is illustrated in FIG. 19. As shown, N input graphs 1901 are provided and used to form adjacency matrix A 1903. The adjacency matrix X is illustratively a sparse/block diagonal matrix. The deep learning model 369 is represented as model 1905, which is a graph CNN or GCNN that takes as input the adjacency matrix A and feature matrix X. The model 1905 produces an output pooling matrix 1907 including the labels for the N input graphs 1901. The output pooling matrix 1907 includes N columns, and is illustratively a sparse matrix. In some embodiments, the GCNN model 1905 includes two hidden layers. The structure of the first and second hidden layers will depend on the number of vertices and label classes, respectively. Rectified Learning Units (ReLUs) may be used for an activation function. These choices (e.g., of the number of hidden layers and activation function), however, may be changed as desired for a particular implementation. FIG. 20 shows an example of an adjacency matrix 2000 produced for the issues and system logs of tables 600 and 1000.

As noted above, the deep learning model 369 in some embodiments comprises or is built using GCNN. GCNN is an exclusive deep learning technique utilized to analyze graph structures. A convolutional neural network (CNN) may be used in computer vision to break down an image into smaller pieces and perform feature extraction. The CNN derives important parts of the input which can be used to decide on output, typically a classification decision. Graph CNN or GCNN, in contrast, performs convolution on a graph rather than an image and classifies the category of the graph. The deep learning model 369 is trained to “observe” each issue as an image using the final graph and classify the relevant issue category to expedite proactive remediation. The deep learning model 369 is trained using the adjacency matrix A, feature matrix X and label matrix L generated by the model training module 367.

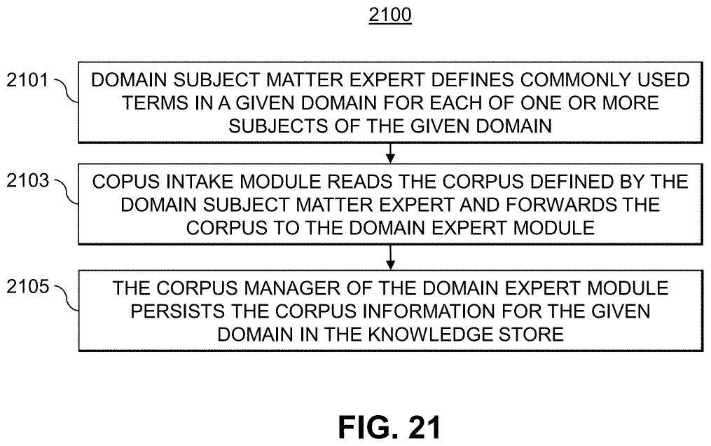

Various operation modes of the system 300 of FIGS. 3A-3D will now be described with respect to the flow diagrams of FIGS. 21-25. FIG. 21 illustrates a domain corpus building operation mode 2100. In step 2101, the domain SMEs 333 define the domain corpus 335 by defining commonly used terms in a given domain for each of one or more subjects of the given domain. Such information is fed to the issue recommendation system 319. In step 2103, the corpus intake module 337 reads the defined domain corpus 335, and forwards the defined domain corpus 335 to the domain expert module 323. In step 2105, the domain expert module 323 via the corpus manager 349 thereof persists the defined domain corpus 335 in the knowledge store 325. For example, if the defined domain corpus 335 is for domain-A 357-A, the corpus manager 349 will store the defined domain corpus 335 as corpus-A 359-A for domain-A 357-A in the knowledge store 325.

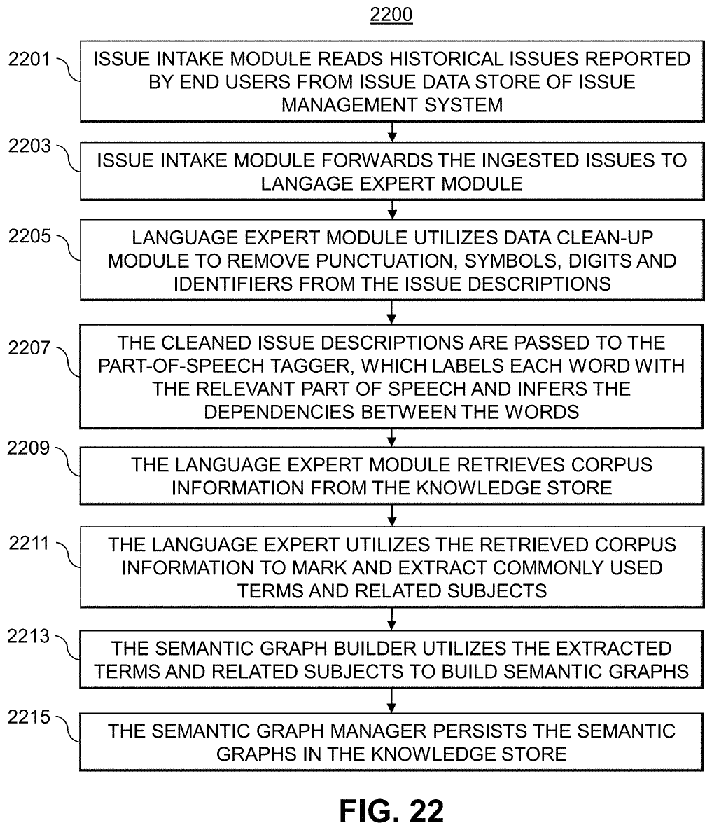

FIG. 22 illustrates a semantic graph building operation mode 2200. In step 2201, the issue intake module 327 reads historical issues reported by end users (e.g., user 301) from the issue data store 315 of the issue management system 311. The issue intake module 327 forwards the ingested issues to the language expert module 339 in step 2203 for further processing. The language expert module 339 utilizes the data clean-up module 341 in step 2205 to perform pre-processing on the ingested issues, where the pre-processing illustratively includes removing punctuation, symbols, digits and identifiers from the issue descriptions. In step 2207, the cleaned issue descriptions are passed to the part-of-speech tagger 343, which labels each word with the relevant part of speech and infers the dependencies between the words. The language expert module 339 in step 2209 requests and retrieves corpus information from the corpus manager 349 of the domain expert module 323 from the relevant domain in the knowledge store 325. A corpus loader of the language expert module 339 receives the corpus information, and in step 2211 utilizes a lemmatizer and the retrieved corpus information to mark and extract the commonly used terms and related subjects from the issue descriptions. This may include generating a bunch of words marked with the relevant part-of-speech dependencies and corpus subjects. In step 2213, the semantic graph builder 347 utilizes the extracted terms and related subjects to build semantic graphs. The semantic graphs are passed to the semantic graph manager 355 in step 2215, and the semantic graph manager 355 persists the semantic graphs in the knowledge store 325 in the relevant domain.

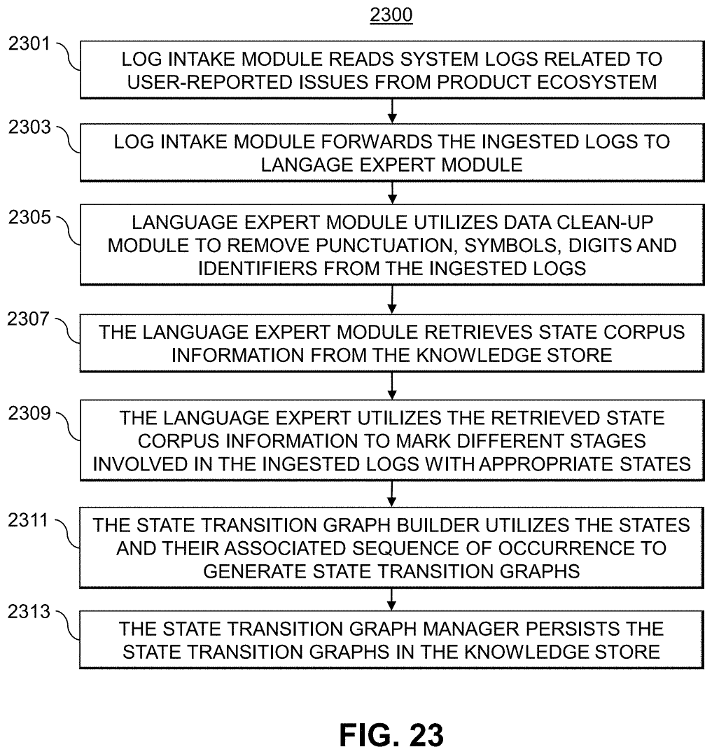

FIG. 23 illustrates a log ingestion and state transition graph building operation mode 2300. In step 2301, the log intake module 331 reads application or system logs 329 related to user-reported issues from the product ecosystem 305. The log intake module 331 forwards the ingested logs to the language expert module 339 in step 2303 for further processing. The language expert module 339 utilizes the data clean-up module 341 in step 2305 to perform pre-processing on the ingested logs, where the pre-processing illustratively includes removing punctuation, symbols, digits and identifiers from the ingested logs. The language expert module 339 in step 2307 requests and retrieves state corpus information from the corpus manager 349 of the domain expert module 323 from the relevant domain in the knowledge store 325. A corpus loader of the language expert module 339 receives the state corpus information, and in step 2309 utilizes a lemmatizer and the retrieved state corpus information to mark different stages involved in the ingested logs with appropriate states. This may include generating a bunch of states and their sequence of occurrence. In step 2311, the state transition graph builder 345 utilizes the states and their sequence of occurrence to build state transition graphs. The state transition graphs are passed to the state transition graph manager 353 in step 2313, and the state transition graph manager 353 persists the state transition graphs in the knowledge store 325 in the relevant domain.

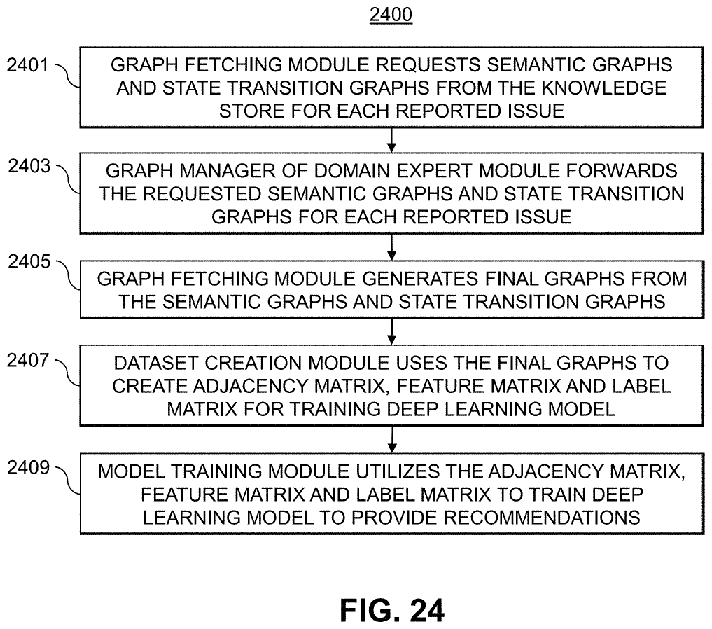

FIG. 24 illustrates a deep learning training operation mode 2400. In step 2401, the graph fetching module 363 requests semantic graphs and state transition graphs from the knowledge store 325, and the domain expert module 323 via graph manager 351 loads the semantic graph and the state transition graphs for each reported issue. In step 2403, the graph manager 351 of the domain expert module 323 utilizes the state transition graph manager 353 and semantic graph manager 355 to forward the requested graphs for each reported issue to the graph fetching module 363. The graph fetching module 363 generates finals graphs from the semantic graphs and state transition graphs in step 2405. The dataset creation module 365 uses the final graphs to prepare the training dataset in step 2407. This may include generating or creating the adjacency matrix, the feature matrix and the label matrix required for training the deep learning model 369. In step 2409, the model training module 367 trains the deep learning model 369 to provide recommendations (e.g., of classifications for issues) utilizing the adjacency matrix, the feature matrix and the label matrix.

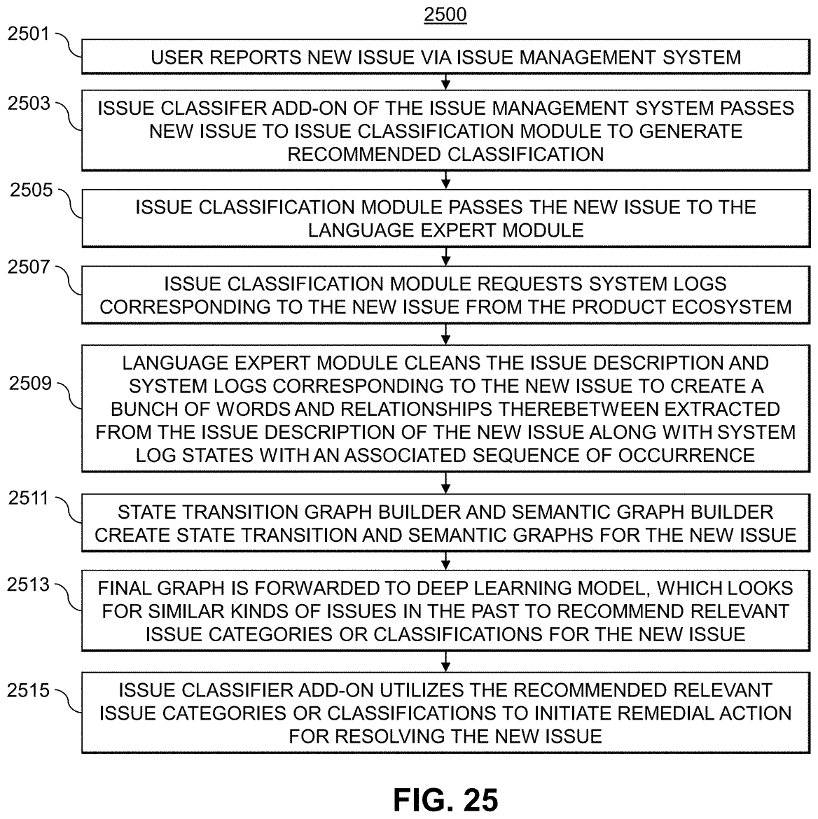

FIG. 25 illustrates a deep learning recommendation operation mode 2500. In step 2501, an end user (e.g., user 301) reports a new issue via the issue management system 311. The issue classifier add-on 317 of the issue management system 311 passes the new issue to the issue classification module 321 of the issue recommendation system 319 to generate recommended classifications for the new issue in step 2503. In step 2505, the issue classification module 321 passes the new issue to the language expert module 339. In step 2507, the issue classification module 321 requests system logs 329 corresponding to the new issue from the product ecosystem 305 (e.g., utilizing the log intake module 331 which provides the system logs 329 to the language expert module 339). In step 2509, the language expert module 339 cleans the issue description and system logs corresponding to the new issue (e.g., using processing similar to that used for the past or historical issues described above) to create a bunch of words and relationships therebetween extracted from the issue description of the new issue along with system log states with their associated sequence of occurrence. State transition graphs and semantic graphs for the new issue are created in step 2511 utilizing the word lists and the state transition graph builder 345 and semantic graph builder 347. The final graph generated by combining the state transition graphs and semantic graphs for the new issue is forwarded to the deep learning model 369 in step 2513. This may include providing the final graph in the form of an adjacency matrix and a feature matrix suitable for input to the deep learning model 369. The deep learning model 369 is configured to “look” for similar kinds of issues in the past to recommend relevant issue categories or classifications for the new issue. In step 2515, the issue classifier add-on 317 utilizes the recommended relevant issue categories or classifications to initiate remedial action for resolving the new issue.

In illustrative embodiments, the proposed systems capture (i) the domain context of an issue through a knowledge store-based semantic graph representation and (ii) the application execution flow context through a state transition graph built using application or system logs. The system then combines the semantic graph and state transition graph to form a final graph representation of the issue, which is then used to predict the issue classification probabilities using deep learning (e.g., a GCNN). The classification probabilities are output, and then used to identify the similarities between a current issue and historical issues previously encountered. Advantageously, such a system can form the basis of a robust issue remediation framework. Such systems are useful in various contexts, including for organizations, enterprises or other entities which have a robust asset portfolio (e.g., of software and hardware devices in an IT infrastructure) that produce information in the form of application or system logs. Each asset may have a particular domain context, which is often scattered in multiple heterogeneous systems. The systems described herein may be used to capture aspects of the software and hardware products, or other assets, from an issue analysis and identification perspective. The systems described can then be used to identify issues faster, and enable faster resolutions without any manual intervention required. The systems described may be used to provide effective diagnostic tools for: retail and enterprise customer desktops, laptops and other hardware through a support assistance framework; a cloud environment; datacenter infrastructures; or anywhere that there is a configurable domain context and application execution logs to identify issues intelligently.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based issue classification utilizing combined representations of semantic and state transition graphs for issues will now be described in greater detail with reference to FIGS. 26 and 27. Although described in the context of system 100 or system 300, these platforms may also be used to implement at least portions of other information processing systems in other embodiments.

FIG. 26 shows an example processing platform comprising cloud infrastructure 2600. The cloud infrastructure 2600 comprises a combination of physical and virtual processing resources that may be utilized to implement at least a portion of the information processing system 100 in FIG. 1 or the system 300 in FIGS. 3A-3D. The cloud infrastructure 2600 comprises multiple virtual machines (VMs) and/or container sets 2602-1, 2602-2, . . . 2602-L implemented using virtualization infrastructure 2604. The virtualization infrastructure 2604 runs on physical infrastructure 2605, and illustratively comprises one or more hypervisors and/or operating system level virtualization infrastructure. The operating system level virtualization infrastructure illustratively comprises kernel control groups of a Linux operating system or other type of operating system.

The cloud infrastructure 2600 further comprises sets of applications 2610-1, 2610-2, . . . 2610-L running on respective ones of the VMs/container sets 2602-1, 2602-2, . . . 2602-L under the control of the virtualization infrastructure 2604. The VMs/container sets 2602 may comprise respective VMs, respective sets of one or more containers, or respective sets of one or more containers running in VMs.

In some implementations of the FIG. 26 embodiment, the VMs/container sets 2602 comprise respective VMs implemented using virtualization infrastructure 2604 that comprises at least one hypervisor. A hypervisor platform may be used to implement a hypervisor within the virtualization infrastructure 2604, where the hypervisor platform has an associated virtual infrastructure management system. The underlying physical machines may comprise one or more distributed processing platforms that include one or more storage systems.

In other implementations of the FIG. 26 embodiment, the VMs/container sets 2602 comprise respective containers implemented using virtualization infrastructure 2604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 or system 300 may each run on a computer, server, storage device or other processing platform element. A given such element may be viewed as an example of what is more generally referred to herein as a “processing device.” The cloud infrastructure 2600 shown in FIG. 26 may represent at least a portion of one processing platform. Another example of such a processing platform is processing platform 2700 shown in FIG. 27.

The processing platform 2700 in this embodiment comprises a portion of system 100 or system 300 and includes a plurality of processing devices, denoted 2702-1, 2702-2, 2702-3, . . . 2702-K, which communicate with one another over a network 2704.

The network 2704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 2702-1 in the processing platform 2700 comprises a processor 2710 coupled to a memory 2712.

The processor 2710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 2712 may comprise random access memory (RAM), read-only memory (ROM), flash memory or other types of memory, in any combination. The memory 2712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 2702-1 is network interface circuitry 2714, which is used to interface the processing device with the network 2704 and other system components, and may comprise conventional transceivers.

The other processing devices 2702 of the processing platform 2700 are assumed to be configured in a manner similar to that shown for processing device 2702-1 in the figure.

Again, the particular processing platform 2700 shown in the figure is presented by way of example only, and system 100 or system 300 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based issue classification utilizing combined representations of semantic and state transition graphs for issues as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, issues, system logs, classifications, recommendations, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured to perform steps of:
obtaining, for a given issue associated with one or more assets of an information technology infrastructure, a description of the given issue and one or more system logs characterizing operation of the one or more assets of the information technology infrastructure;
generating one or more semantic graphs characterizing the description of the given issue and one or more state transition graphs characterizing a sequence of occurrence of one or more states of the operation of the one or more assets of the information technology infrastructure;
providing a combined representation of the one or more semantic graphs and the one or more state transition graphs for the given issue to a machine learning model;
identifying one or more recommended classifications for the given issue based at least in part on an output of the machine learning model; and
initiating one or more remedial actions in the information technology infrastructure based at least in part on the one or more recommended classifications for the given issue.

2. The apparatus of claim 1 wherein a given one of the one or more semantic graphs represents at least a subset of words of the description of the given issue as nodes with edges connecting the nodes representing placement of the words relative to one another in the description of the given issue.

3. The apparatus of claim 2 wherein the given issue is associated with a given domain, and wherein one or more of the words in the subset of words of the description of the given issue comprise terms from a domain-specific glossary of terms in a corpus defined for the given domain.

4. The apparatus of claim 3 wherein generating the given semantic graph comprises assigning a part of speech category to each of the words in the subset of words of the description of the given issue.

5. The apparatus of claim 1 wherein generating the one or more semantic graphs and the one or more state transition graphs comprises performing preprocessing on the description of the given issue and the one or more system logs.

6. The apparatus of claim 5 wherein performing preprocessing on the description of the given issue and the one or more system logs comprises at least one of:
removing digits, punctuation and symbols;
removing alphanumeric sequences; and
removing identifiers.

7. The apparatus of claim 1 wherein a given one of the one or more state transition graphs represents states of operation of the one or more assets of the information technology infrastructure as nodes with edges connecting the nodes representing a sequence of occurrence of the states of operation of the one or more assets of the information technology infrastructure.

8. The apparatus of claim 7 wherein the given issue is associated with a given domain, and wherein one or more of the states of operation of the one or more assets of the information technology infrastructure comprise terms from a domain-specific glossary of states in a corpus defined for the given domain.

9. The apparatus of claim 1 wherein the machine learning model comprises a graph convolutional neural network.

10. The apparatus of claim 9 wherein the graph convolutional neural network comprises two or more hidden layers, a first one of the two or more hidden layers having a structure determined based at least in part on a number of vertices in the combined representation of the one or more semantic graphs and the one or more state transition graphs for the given issue, a second one of the two or more hidden layers having a structure determined based at least in part on a number of possible classification labels for the given issue.

11. The apparatus of claim 9 wherein the combined representation of the one or more semantic graphs and the one or more state transition graphs for the given issue comprises a feature matrix and an adjacency matrix, the feature matrix comprising an identity matrix with elements representing vertices of the one or more semantic graphs and the one or more state transition graphs, the adjacency matrix comprising elements representing whether pairs of vertices of the one or more semantic graphs and the one or more state transition graphs are adjacent to one another.

12. The apparatus of claim 1 wherein the at least one processing device is further configured to train the machine learning model utilizing combined representations of one or more historical semantic graphs and one or more historical state transition graphs generated for one or more historical issues associated with the assets of the information technology infrastructure.

13. The apparatus of claim 12 wherein the representations of the one or more historical issues associated with assets of the information technology infrastructure comprise:
a feature matrix comprising an identity matrix with elements representing vertices of the one or more historical semantic graphs and the one or more historical state transition graphs generated for the one or more historical issues;
an adjacency matrix comprising elements representing whether pairs of vertices of the one or more historical semantic graphs and the one or more historical state transition graphs are adjacent to one another; and
a label matrix comprising elements representing classification labels for the one or more historical issues.

14. The apparatus of claim 1 wherein initiating the one or more remedial actions comprises modifying a configuration of the one or more assets of the information technology infrastructure.

15. A computer program product comprising a non-transitory processor-readable storage medium having stored therein program code of one or more software programs, wherein the program code when executed by at least one processing device causes the at least one processing device to perform steps of:
obtaining, for a given issue associated with one or more assets of an information technology infrastructure, a description of the given issue and one or more system logs characterizing operation of the one or more assets of the information technology infrastructure;
generating one or more semantic graphs characterizing the description of the given issue and one or more state transition graphs characterizing a sequence of occurrence of one or more states of the operation of the one or more assets of the information technology infrastructure;
providing a combined representation of the one or more semantic graphs and the one or more state transition graphs for the given issue to a machine learning model;
identifying one or more recommended classifications for the given issue based at least in part on an output of the machine learning model; and
initiating one or more remedial actions in the information technology infrastructure based at least in part on the one or more recommended classifications for the given issue.

16. The computer program product of claim 15 wherein the machine learning model comprises a graph convolutional neural network, the graph convolutional neural network comprising two or more hidden layers, a first one of the two or more hidden layers having a structure determined based at least in part on a number of vertices in the combined representation of the one or more semantic graphs and the one or more state transition graphs for the given issue, a second one of the two or more hidden layers having a structure determined based at least in part on a number of possible classification labels for the given issue.

17. The computer program product of claim 15 wherein the machine learning model comprises a graph convolutional neural network, the combined representation of the one or more semantic graphs and the one or more state transition graphs for the given issue comprises a feature matrix and an adjacency matrix, the feature matrix comprising an identity matrix with elements representing vertices of the one or more semantic graphs and the one or more state transition graphs, the adjacency matrix comprising elements representing whether pairs of vertices of the one or more semantic graphs and the one or more state transition graphs are adjacent to one another.

18. A method comprising:
obtaining, for a given issue associated with one or more assets of an information technology infrastructure, a description of the given issue and one or more system logs characterizing operation of the one or more assets of the information technology infrastructure;
generating one or more semantic graphs characterizing the description of the given issue and one or more state transition graphs characterizing a sequence of occurrence of one or more states of the operation of the one or more assets of the information technology infrastructure;
providing a combined representation of the one or more semantic graphs and the one or more state transition graphs for the given issue to a machine learning model;
identifying one or more recommended classifications for the given issue based at least in part on an output of the machine learning model; and
initiating one or more remedial actions in the information technology infrastructure based at least in part on the one or more recommended classifications for the given issue;
wherein the method is performed by at least one processing device comprising a processor coupled to a memory.

19. The method of claim 18 wherein the machine learning model comprises a graph convolutional neural network, the graph convolutional neural network comprising two or more hidden layers, a first one of the two or more hidden layers having a structure determined based at least in part on a number of vertices in the combined representation of the one or more semantic graphs and the one or more state transition graphs for the given issue, a second one of the two or more hidden layers having a structure determined based at least in part on a number of possible classification labels for the given issue.

20. The method of claim 18 wherein the machine learning model comprises a graph convolutional neural network, the combined representation of the one or more semantic graphs and the one or more state transition graphs for the given issue comprises a feature matrix and an adjacency matrix, the feature matrix comprising an identity matrix with elements representing vertices of the one or more semantic graphs and the one or more state transition graphs, the adjacency matrix comprising elements representing whether pairs of vertices of the one or more semantic graphs and the one or more state transition graphs are adjacent to one another.
